(19) United States
(12) Patent Application Publication
(10) Pub. No.: US 2003/0132906 A1
(43) Pub. Date: Jul. 17, 2003

(54) Gray scale display reference voltage generating circuit and liquid crystal display device using the same

(76) Inventors: Shigeki Tanaka, Nara-shi (JP); Yoshinori Ogawa, Yamatotakada-shi (JP)

Correspondence Address: HARNESS, DICKEY & PIERCE, P.L.C., P.O. BOX 8910, RESTON, VA, 20195, US

(21) Appl. No.: 10/321,534

(22) Filed: Dec. 18, 2002

(30) Foreign Application Priority Data
Jan. 16, 2002 (JP) 2002-7565
Aug. 9, 2002 (JP) 2002-233699

(51) Int. Cl. G09G 3/36

(52) U.S. Cl. 345/89

(57) ABSTRACT

A gray scale display reference voltage generating circuit for generating a reference voltage for a gray scale display used for performing digital/analog conversion on display data comprising: a reference voltage generating section for producing reference voltages of a plurality of levels; a correction information storing section for storing quantity of adjustment for the reference voltages; and an adjustment section for adjusting the reference voltages based upon the quantity of adjustment stored in the correction information storing section.

### CROSS-REFERENCES TO RELATED APPLICATIONS

This application is related to Japanese Patent Applications Nos. 2002-7565 and 2002-233699, filed on Jan. 16, 2002 and Aug. 9, 2002 whose priorities are claimed under 35 USC §119, the disclosures of which are incorporated by reference in their entirety.

### BACKGROUND OF THE INVENTION

1. Field of the Invention

The present invention relates to a reference voltage generating circuit for a gray scale display (hereinafter referred to as a gray scale reference voltage generating circuit) and a liquid crystal display device using the same.

2. Description of Related Art

A gray scale reference voltage generating circuit is for generating intermediate voltages between two voltages. For example, the intermediate voltages are generated by using resistance division at a liquid crystal driving section in a liquid crystal display device of an active matrix type. A resistance for the resistance division has a resistance ratio called gamma correction for correcting optical characteristics of a liquid crystal material according to the resistance ratio, to thereby realize a more natural-gray scale display.

Explained hereinbelow are a structure of a liquid crystal display device provided with the gray scale reference voltage generating circuit, a structure of a liquid crystal panel of a TFT (thin film transistor) in the liquid crystal display device, a liquid crystal driving waveform thereof and a structure of a source driver.

FIG. 11 shows a block diagram of a liquid crystal display device of a TFT type that is a typical example of an active matrix type. This liquid crystal display device is divided into a liquid crystal display section and a liquid crystal driving circuit (liquid crystal driving section) for driving the liquid crystal display section. The liquid crystal display section includes a liquid crystal panel 1 of the TFT type. Disposed in the liquid crystal panel 1 are liquid crystal display elements (not shown) and a counter electrode (common electrode) 2 described in detail later.

Mounted on the liquid crystal driving circuit are a source driver 3 and a gate driver 4 both composed of an IC (integrated circuit), a controller 5 and a liquid crystal driving power source 6.

The source driver 3 and the gate driver 4 are generally formed by a method in which, for example, a TCP (Tape Carrier Package) having the above-mentioned IC chip mounted on a wiring film is mounted on an ITO (Indium Tin Oxide) terminal of the liquid crystal panel for connection, or a method in which the IC chip is directly mounted on the ITO terminal via an ACF (Anisotropic Conductive Film) with a thermo-compression bonding for connection.

The controller 5 inputs display data D and a control signal S1 to the source driver 3, while it inputs a vertical synchronization signal S2 to the gate driver 4. Further, the controller 5 inputs a horizontal synchronization signal to the source driver 3 and the gate driver 4.

In this structure, the display data inputted from outside is inputted as the display data D that is a digital signal to the source driver 3 via the controller 5. The source driver 3 time-shares the inputted display data D, latches the time-shared data to a first source driver to an n-th source driver, and then performs a D/A conversion (digital-to-analog conversion) in synchronization with the horizontal synchronization signal input by the controller 5. Then, an analog voltage for a gray scale display (hereinafter referred to as a gray scale display voltage) formed by subjecting the time-shared display data D to the D/A conversion is outputted via a source signal line (not shown) to the corresponding liquid crystal display element in the liquid crystal panel 1.

FIG. 12 shows a structure of the liquid crystal panel 1. Disposed in the liquid crystal panel 1 are pixel electrodes 11, pixel capacitors 12, TFTs 13 for controlling the turning-on and turning-off of the voltage to be applied to the pixel electrodes 11, source signal lines 14, gate signal lines 15 and counter electrode 16 (corresponding to the counter electrode 2 in FIG. 11). The liquid crystal display element A of one pixel is constructed of the pixel electrode 11, pixel capacitor 12 and TFT 13.

The gray scale display voltage corresponding to the brightness of the pixel to be used for display is applied to the source signal line 14 from the source driver 3 in FIG. 11. On the other hand, applied to the gate signal line 15 from the gate driver 4 is a scanning signal for successively turning on the TFTs 13 arranged in a column direction. The gray scale display voltage of the source signal line 14 is applied via the TFT 13 that is in ON-state to the pixel electrode 11 connected to a drain of the TFT :13, to thereby be accumulated in the pixel capacitor 12 between the pixel electrode 11 and the counter electrodes 16. Thus, the light transmittance of the liquid crystal is changed in accordance with the gray scale display voltage, executing a pixel display.

FIG. 13 and FIG. 14 show an example of a liquid crystal display driving waveform. In FIG. 13 and FIG. 14, reference numerals 21 and 25 denote the driving waveforms of the source driver 3, while reference numerals 22 and 26 denote the driving waveforms of the gate driver 4. Reference numerals 23 and 27 denote the potentials of the counter electrode 16, while reference numerals 24 and 28 denote the voltage waveforms of the pixel electrode 11. In this case, the voltage applied to the liquid crystal material is a potential difference between the pixel electrode 11 and the counter electrode 16 and is indicated by the hatching in the figures.

For example, in the case of FIG. 13, the TFT 13 is turned on only when the level of the driving waveform 22 of the gate driver 4 is at H-level, by which a voltage of the difference between the driving waveform 21 of the source driver 3 and the potential 23 of the counter electrode 16 is applied to the pixel electrode 11. Subsequently, the level of the driving waveform 22 of the gate driver 4 comes to be at L-level, by which the TFT 13 is turned off. In this case, the aforementioned voltage is retained due to the provision of the pixel capacitor 12 for the pixel.

The case in FIG. 14 is the same as that in FIG. 13. However, it is to be noted that FIG. 13 and FIG. 14 respectively show the cases where different voltages are applied to the liquid crystal material. In the case of FIG. 13, the application voltage is higher than that of FIG. 14. Thus, varying the voltage applied as an analog voltage to the liquid crystal material analogically changes the light transmittance of the liquid crystals, thereby providing multilevel gray scale display. It is to be noted that the number of levels of gray scale that can be displayed depends on the number of analog voltages to be selectively applied to the liquid crystal material.

FIG. 15 is one example of a block diagram showing the n-th source driver of the source driver 3 in FIG. 11. Display data D of the inputted digital signal includes display data (DR, DG, DB) of R (red), G (green) and B (blue). This display data D is, after temporarily latched in an input latch circuit 31, time-sharingly stored at a sampling memory 33 in synchronization with the operation of a shift register 32 that is shifted by a start pulse SP and clock CK supplied from the controller 5. Thereafter, it is collectively transferred to a hold memory 34 based upon the horizontal synchronization signal (not shown) from the controller 5. Reference numeral S denotes a cascade output.

A gray scale display reference voltage generating circuit 39 generates a reference voltage at each level on the basis of a voltage VR supplied from an external reference voltage generating circuit (corresponding to the liquid crystal driving power source 6 of FIG. 11). The data in the hold memory 34 is transmitted to a D/A converter circuit (Digital-to-Analog converter circuit) 36 via a level shifter circuit 35 and converted into an analog voltage on the basis of the reference voltage at each level from the gray scale display reference voltage generating circuit 39. Then, the analog voltage is outputted as the aforementioned gray scale display voltage from a liquid crystal driving voltage output terminal 38 to the source signal line 14 of each liquid crystal display element A by an output circuit 37. That is, the number of levels of the reference voltages becomes the number of levels of gray scale that can be displayed.

FIG. 16 shows the construction of the gray scale display reference voltage generating circuit 39 that generates intermediate voltages for outputting a plurality of reference voltages as described above. It is to be noted that the gray scale display reference voltage generating circuit 39 of FIG. 16 generates 64 levels of reference voltages.

This gray scale display reference voltage generating circuit 39 is constructed of nine gray scale voltage input terminals indicated by V0, V8, V16, V24, V32, V40, V48, V56 and V64, resistor elements R0 through R7 having a resistance ratio for a gamma correction and a total of 64 resistors (not shown) that are in groups of eight serially connected across both terminals of the resistor elements R0 through R7. As described above, the resistance ratio called the gamma correction is built into the source driver, providing the liquid crystal driving output voltage to be converted the gray scale display voltage with a line graph characteristic. Therefore, correcting the optical characteristics of the liquid crystal material by the aforementioned resistance ratio can provide natural gray scale display conforming to the optical characteristics of the liquid crystal material. An example of the liquid crystal driving output voltage characteristic of the conventional gray scale display reference voltage generating circuit 39 is shown in FIG. 17.

However, the aforementioned conventional gray scale display reference voltage generating circuit has the problems as follows. Specifically, the optimum gamma correction characteristic (the line graph characteristic of the liquid crystal driving output voltage shown in FIG. 17) varies depending on the type of the liquid crystal material and the number of pixels of the liquid crystal panel and varies in every liquid crystal module. The resistance division ratio of the gray scale display reference voltage generating circuit 39 incorporated into the source driver 3 is determined during the design phase of the source driver 3. Therefore, when changing the gamma correction characteristic according to the type of the adopted liquid crystal material and the number of pixels of the liquid crystal panel, there is the problem that the source driver 3 is required to be remade on all such occasions.

There can be considered a method for providing reference voltage adjusting means for adjusting the plurality of intermediate voltages supplied from the external reference voltage generating circuit to the intermediate voltage input terminals V0 through V64, whereby the intermediate voltages to be supplied to each of the intermediate voltage input terminals V0 through V64 are adjusted by the reference voltage adjusting means.

However, the provision of the reference voltage adjusting means increases the number of terminals and the circuit scale, leading to an increase in manufacturing cost.

A demand for liquid crystal displays (LCD) has been enlarged because of their characteristics such as being compact, low in power consumption or the like. Further, a development has been promoted from the viewpoint of their function for making commercial products having a large screen, high precision and multi-gray-scale.

However, the LCDs have a narrow viewing angle compared to a CRT or the like, especially having a technical problem that the viewing angle in the upward and downward directions is narrow.

In a normally white transmissive-type TN (twisted nematic) LCD employed for office automation (abbreviated to OA hereinafter), for example, orientation state of the liquid crystal molecules is changed by changing voltage applied to a liquid crystal sandwiched between two deflection plates arranged such that their deflection axes are perpendicular to each other, whereby light linearly deflected by the deflection plate at the light-incident side is elliptically deflected and only light in the deflection axis direction at the light-emitted side is transmitted to thereby control its brightness.

In the LCD used for OA, the orientation films of a glass substrate at a thin-film transistor (TFT) side and a glass substrate at a color filter (CF) side are respectively subjected to a rubbing processing in directions shown in FIG. 18(a), to thereby attain liquid crystal molecules oriented in the respective directions.

The liquid crystal molecules are oriented in a twisted mode in a lateral direction when voltage is not applied, while they are oriented in a vertical direction when voltage is applied. The refractive index is different in the major axis direction and minor axis direction of the liquid crystal molecule, so that there is a refractive index anisotropy in light transmission with the liquid crystal molecules lying, while there is a refractive index isotropy with the liquid crystal molecules standing upright. Accordingly, the rotation of light deflection is different depending upon voltage applied to the liquid crystal.

The rotational amount of the light deflection is regulated by a product (retardation) of a liquid crystal cell gap and the refractive index anisotropy (refractive index in the major axis direction—refractive index in the minor axis direction) of the liquid crystal molecules.

When each glass substrate is subject to the rubbing process in each direction shown in FIG. 18(a) for orientating the liquid crystal molecules, a retardation anisotropy appears since the liquid crystal molecules are twisted as shown in FIG. 18(b). The viewing angle is relatively wide in the right and left directions due to a relatively symmetric orientation. On the other hand, the viewing angle in the upward and downward directions becomes narrow due to a remarkably asymmetric orientation. The liquid crystal molecules are seemed to be laid down when seen from the above, while they are seemed to be risen when seen from the below. As a result, a black color is remarkably emphasized when seen from the above, while a gray scale inversion phenomenon becomes a problem when seen from the below. This is a great problem in particular in a full-color device frequently using a gray scale mode.

In order to achieve a wide viewing characteristic of the LCD, there has generally been known as a conventional technique a structure in which one pixel is divided into a plurality of sub-pixels that are small pixel dots, and between the divided small pixel dots, a plurality of capacitors are formed to which different voltages are applied. This method requires to divide a pixel dot, and further to form a pixel in plural times for forming the capacitors, thereby making the manufacturing process of the liquid crystal panel complicated compared to the ordinary process. This consequently brings a reduced yield and increased cost.

### SUMMARY OF THE INVENTION

This invention is a gray scale display reference voltage generating circuit for generating a reference voltage for a gray scale display used for performing digital/analog conversion on display data comprising: a reference voltage generating section for producing reference voltages of a plurality of levels; a correction information storing section for storing quantity of adjustment for the reference voltages; and an adjustment section for adjusting the reference voltages based upon the quantity of adjustment stored in the correction information storing section.

By this construction, a reference voltage can be changed only by rewriting the information stored in the correction information storing section, thereby being capable of adjusting the reference voltage by a user in accordance with the characteristics of a liquid crystal material or liquid crystal display device.

### BRIEF DESCRIPTION OF THE DRAWINGS

The present invention will become more fully understood from the detailed description given hereinbelow and the accompanying drawings that are given by way of illustration only, and thus are not to be considered as limiting the present invention.

FIG. 1 is a block diagram showing a construction of a source driver in a first embodiment of the present invention;

FIG. 2 is a block diagram showing a construction of one embodiment of a liquid crystal display device according to the present invention;

FIG. 3 is a block diagram showing a construction of a gray scale display reference voltage generating circuit of the invention;

FIG. 4 is a schematic block diagram showing a gamma correction adjustment circuit in FIG. 1:

FIG. 5 is an explanatory view of the operation of a constant current source for obtaining an output voltage higher than a reference voltage and for obtaining an output voltage lower than the reference voltage;

FIG. 6 is a diagram showing the circuit construction of a constant current source section in the gamma correction adjustment circuit;

FIG. 7 is a view showing the characteristic of the liquid crystal driving output voltage by the gray scale display reference voltage generating circuit shown in FIG. 1;

FIG. 8 is an explanatory view for the contents of information stored in a non-volatile memory of the invention;

FIG. 9 is an explanatory view for the correction characteristic of gray scale display data of the invention;

FIG. 10 is a block diagram showing a construction of a source driver according to a second embodiment of the invention;

FIG. 11 is a block diagram showing a construction of a liquid crystal display device of a TFT type;

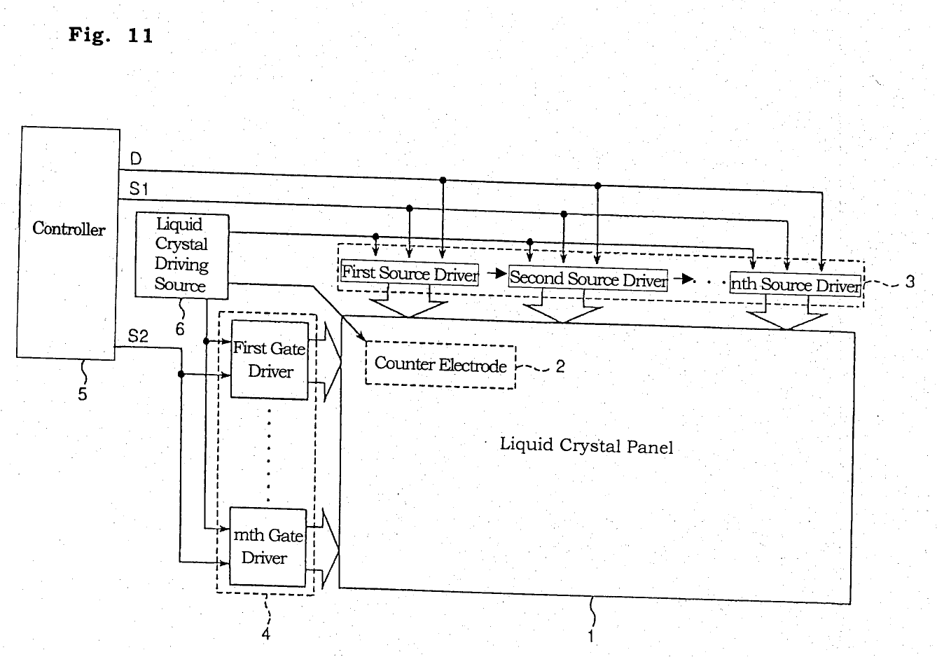

FIG. 12 is a view showing a construction of a liquid crystal panel in FIG. 11;

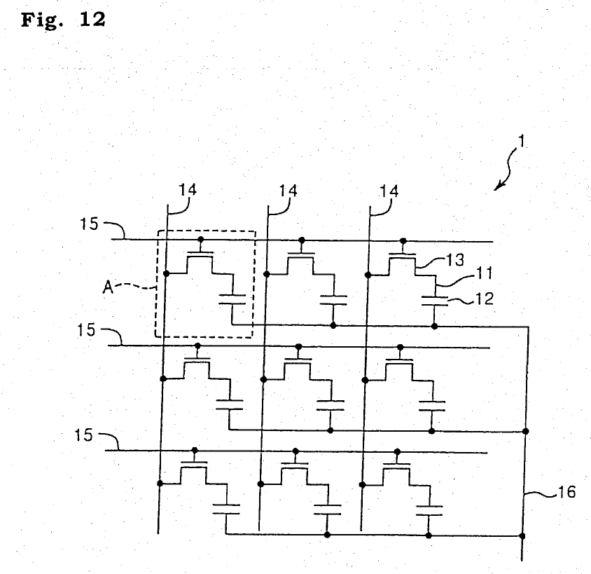

FIG. 13 is a view showing one example of a liquid crystal driving waveform;

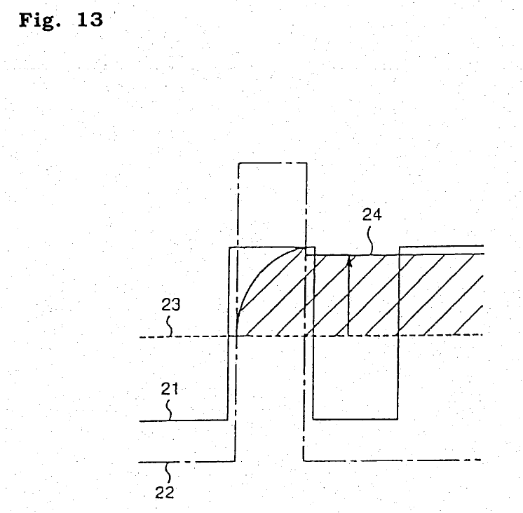

FIG. 14 is a view showing a liquid crystal driving waveform in case where applied voltage is lower that that of FIG. 13;

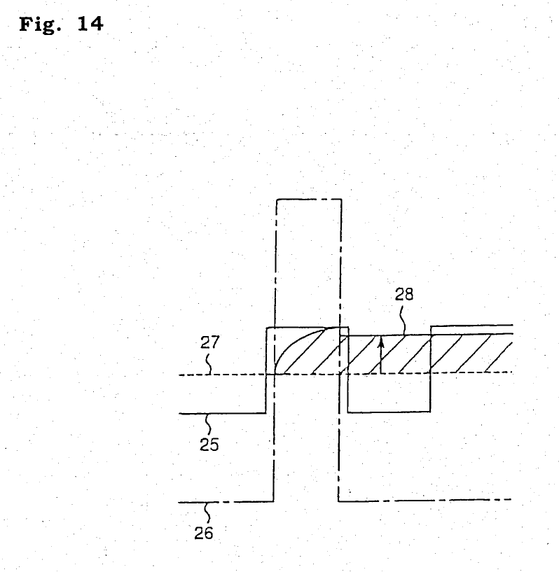

FIG. 15 is a block diagram showing a source driver in FIG. 11;

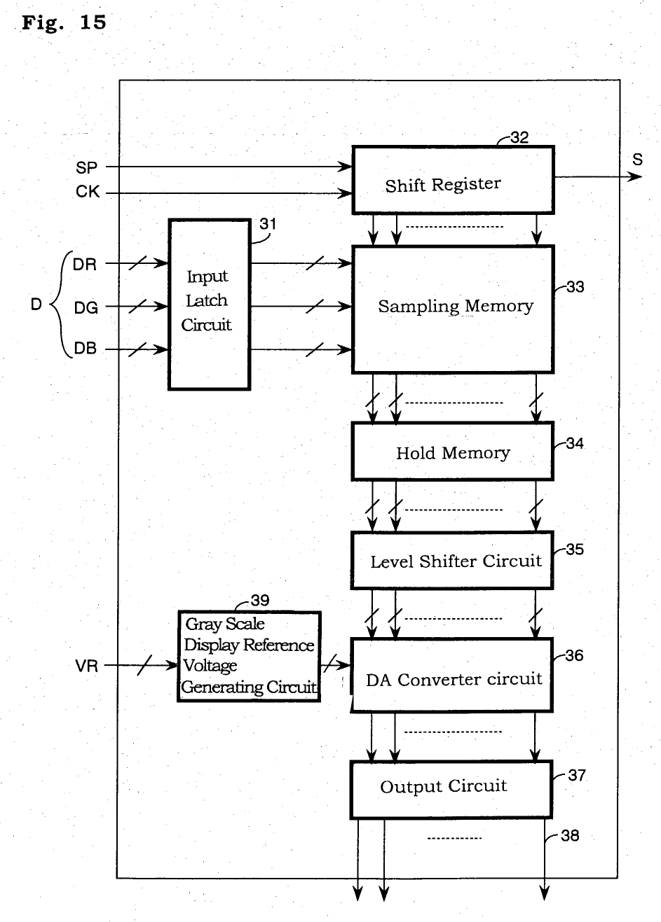

FIG. 16 is a view showing a construction of the gray scale display reference voltage generating circuit in FIG. 15;

FIG. 17 is a view showing an -example of the characteristic of the liquid crystal driving output voltage by the gray scale display reference voltage generating circuit in FIG. 16;

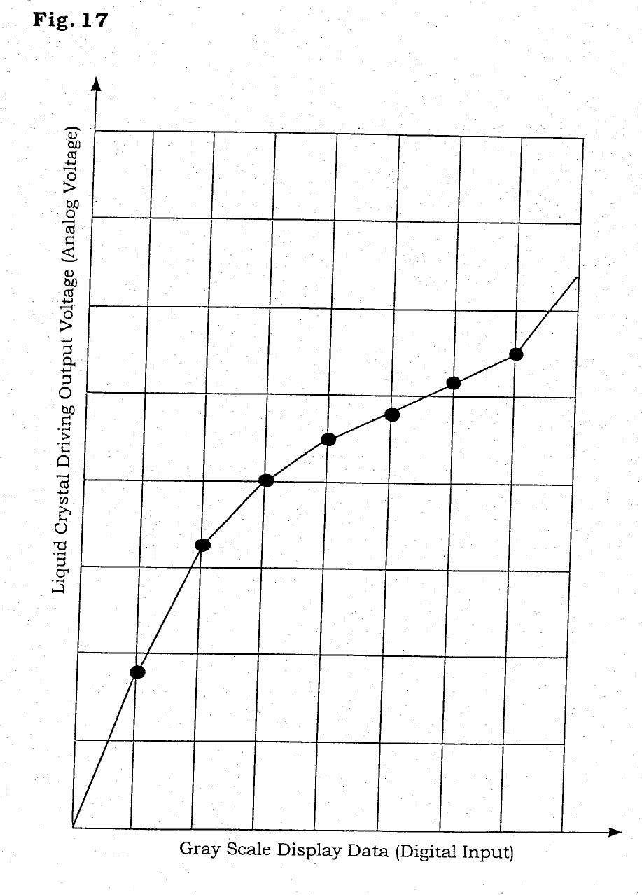

FIG. 18 is a view showing an orientation state of a conventional liquid crystal;

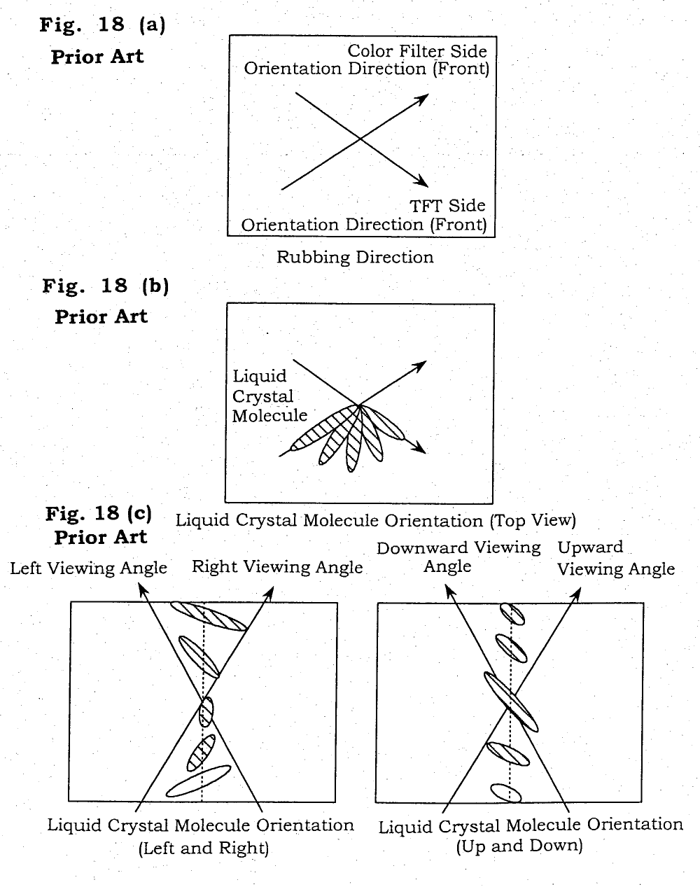

FIG. 19 is a block diagram showing a construction of a liquid crystal display device according to a third embodiment of the invention;

FIG. 20 is a block diagram showing a construction of a gray scale display reference voltage generating circuit according to the third embodiment of the invention;

FIG. 21 is a view showing a circuit construction of a constant current source section in a gamma correction adjustment circuit according to the third embodiment of the invention;

FIG. 22 is a view for explaining two gamma conversion characteristics of the liquid crystal driving output voltage in the third embodiment of the invention;

FIG. 23 is a view for explaining a pixel state in the liquid crystal display device using two types of gamma conversion characteristics in the third embodiment of the invention;

FIG. 24 is a view for explaining pixel states of two continuous frames with respect to FIG. 23;

FIG. 25 is a view for explaining a pixel state in the liquid crystal display device using three types of gamma conversion characteristics in the third embodiment of the invention;

FIG. 26 is a view for explaining a pixel state in the liquid crystal display device using three types of gamma conversion characteristics in the third embodiment of the invention;

FIG. 27 is a view for explaining pixel states of two continuous frames with respect to FIG. 26;

FIG. 28 is a view for explaining three gamma conversion characteristics of liquid crystal driving output voltage in the third embodiment;

FIG. 29 is a view for explaining a pixel state in the liquid crystal display device using five types of gamma conversion characteristics in the third embodiment of the invention;

FIG. 30 is a view for explaining pixel states of two continuous frames with respect to FIG. 29;

FIG. 31 is a view for explaining five gamma conversion characteristics of liquid crystal driving output voltage in the third embodiment;

FIG. 32 is a block diagram showing a construction of a liquid crystal display device according to a fourth embodiment of the invention;

FIG. 33 is a block diagram showing a construction of a liquid crystal display device according to the fourth embodiment of the invention;

FIG. 34 is a block diagram showing constructions of a reference voltage generating circuit and selector circuit in the fourth embodiment of the invention;

FIG. 35 is a block diagram showing a construction of the reference voltage generating circuit in the fourth embodiment of the invention;

FIG. 36 is a view for explaining gamma conversion characteristics of liquid crystal driving output voltage in the fourth embodiment;

FIG. 37 is a view for explaining a pixel state in the liquid crystal display device using three types of gamma conversion characteristics in the fourth embodiment of the invention;

FIG. 38 is a view for explaining pixel states of two continuous frames with respect to FIG. 37; and

FIG. 39 is a block diagram showing another construction of the reference voltage generating circuit in the fourth embodiment.

### DESCRIPTION OF THE PREFERRED EMBODIMENTS

The present invention provides a gray scale display reference voltage generating circuit capable of optionally changing the gamma correction characteristic by a user according to characteristics of the liquid crystal material and liquid crystal panel without increasing the manufacturing cost, and a liquid crystal display device using the same.

Further, the present invention provides a liquid crystal display device capable of electrically widening a viewing angle without making the manufacturing process complicated.

In this invention, it is preferable that the correction information storing section is constructed of a non-volatile memory. By this construction, the previous correction state adjusted by the user can be applied as it is to the next display.

Further, the reference voltage generating section, the correction information storing section and the adjustment section may be independently provided for every plural color components.

By this construction, the reference voltage can be independently adjusted for every color, to thereby be capable of controlling the display quality of the display panel with high precision.

Further, the gray scale display reference voltage generating circuit of this invention can be applied to any liquid crystal display devices each having different characteristic, thereby achieving commonization in parts of the liquid crystal display device. As a result, manufacturing cost can be reduced.

This invention is a liquid crystal display device comprising: a reference voltage generating section for producing a plurality of reference voltages for a gray scale display used for performing digital/analog conversion on display data; a correction information storing section for storing quantity of adjustment of one type or quantities of adjustment of a plurality of types with respect to the reference voltages; an adjustment section for adjusting the produced reference voltages based upon the quantities of adjustment stored in the correction information storing section; and a control section for controlling an operation of the adjustment section, wherein the control section reads out the quantities of adjustment of different types from the correction information storing section for every predetermined number of scanning lines in one frame of a display screen, and gives the read-out quantities of adjustment to the adjustment section.

Moreover, the adjustment section may adjust the reference voltage based upon the applied quantity of adjustment in synchronization with the scanning signal that is for displaying the display screen. By this operation, the reference voltage can be adjusted for every predetermined scanning line, thereby being capable of finely adjusting a viewing angle.

The scanning line means here a so-called gate signal line. The phrase “every predetermined scanning line” means that the reference voltage may be adjusted for every scanning line or for every optional plural scanning lines.

The control section may use a controller LSI such as an MPU (micro-processing unit) for rewriting the quantity of adjustment stored in the correction information storing section. By enabling the rewriting, finer adjustment can be made so as to widen a viewing angle.

And, this invention is a liquid crystal display device, wherein the correction information storing section comprises a first storage section for storing first adjustment data in case where a voltage having positive polarity is applied to a pixel and a second storage section for storing second adjustment data in case where a voltage having negative polarity is applied to a pixel, the reference voltage generating section comprises a first voltage generating section for producing a reference voltage for a positive polarity gray scale display and a second voltage generating section for producing a reference voltage for a negative polarity gray scale display, the adjustment section comprises a first adjustment section for adjusting the reference voltage produced by the first voltage generating section based upon the first adjustment data stored in the first storage section and a second adjustment section for adjusting the reference voltage produced by the second voltage generating section based upon the second adjustment data stored in the second storage section, and the liquid crystal display device further comprising a selecting section for selecting either one of the adjusted reference voltages outputted from the first and second adjustment sections based upon a polarity inverting signal applied from the control section, wherein a gray scale correction is performed for every scanning line based upon the selected reference voltage.

By this construction, visual optimum adjustment in color change can be realized for every scanning line to which positive or negative voltage is applied.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The present invention will be explained in detail hereinbelow based upon the embodiments shown in the figures, by which the invention is not limited thereto.

[First Embodiment]

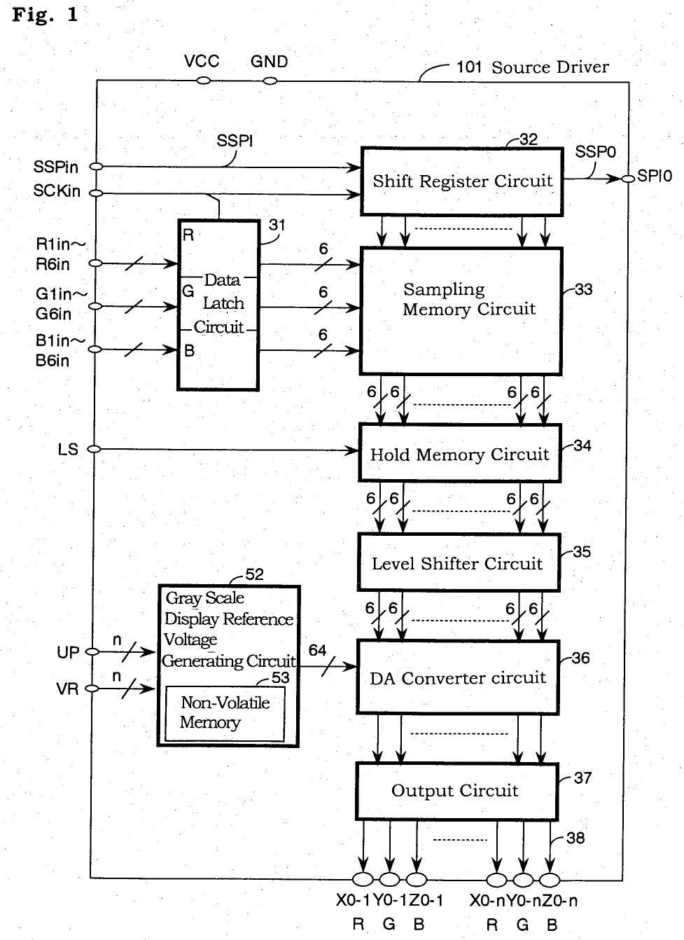

FIG. 1 is a block diagram showing a construction of a source driver in the first embodiment provided with a gray scale display reference voltage generating circuit of this invention.

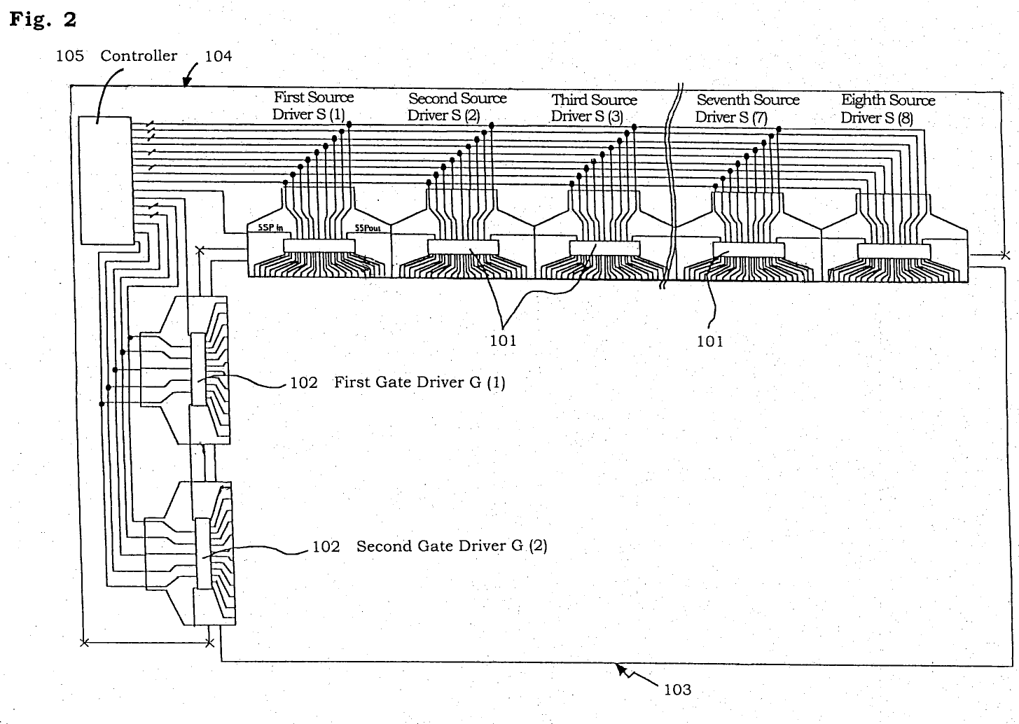

FIG. 2 is a schematic block diagram showing a construction of one embodiment of a liquid crystal display device using the source driver 101. In FIG. 2, the liquid crystal display device is composed of a liquid crystal display section 103 and a liquid crystal driving section 104.

The liquid crystal driving section 104 has the source driver 101, a gate driver 102 and a controller 105.

The controller 105, like the conventional one, inputs display data and control signal to the source driver 101, inputs a vertical synchronization signal to the gate driver 102 and inputs a horizontal synchronization signal to the source driver 101 and the gate driver 102.

The inputted display data is time-shared to be applied to each source driver, D/A converted in synchronization with the horizontal synchronization signal and outputted to a liquid crystal display element as a predetermined gray scale display voltage.

As shown in FIG. 1, the source driver 101 is composed of a shift register circuit 32, data latch circuit 31, sampling memory circuit 33, hold memory circuit 34, level shifter circuit 35, D/A converter circuit 36, output circuit 37 and gray scale display reference voltage generating circuit 52.

The operation of the source driver 101 will be explained using a first source driver S(1) that is positioned at a first stage.

The shift register circuit 32 is a circuit for shifting, i.e., transferring a start pulse input signal SSPI. The signal SSPI is outputted from a terminal (not shown) of the controller 105 and inputted into an input terminal SSPin of the source driver 101. The signal SSPI is a signal synchronized with the horizontal synchronization signals of the display data signals R, G and B.

The start pulse input signal SSPI is shifted by a clock signal SCK that is outputted from a terminal SCK of the controller 105 and inputted to an input terminal SCKin of the source driver 101.

The start pulse input signal SSPI shifted at the shift register 32 is successively transferred to the shift register 32 of the source driver 101 in the eighth source driver S(8) in FIG. 2, in case where eight source drivers are employed.

On the other hand, 6-bit display data signals R, G and B respectively outputted from terminals R1 to R6, terminals G1 to G6 and terminals B1 to B6 of the controller 105 are serially inputted respectively to input terminals R1in to R6in, input terminals G1in to G6in and input terminals Bin to B6in in synchronization with the rising edge of a clock signal/SCK (reverse signal of the clock signal SCK), temporarily latched at the data latch circuit 31, and then, sent to the sampling memory circuit 33.

The sampling memory circuit 33 samples the display data signal (18 bits in total, that is, 6 bits each of R, G and B) time-sharingly sent thereto with the output signal of each shift register circuit 32, and stores the respective data until a latch signal LS outputted from the: controller 105 to the hold memory circuit 34 is inputted to the terminal LS of the source driver 101.

At the hold memory circuit 34, the display data signal inputted from the sampling memory circuit 33 is latched by the latch signal LS at the time when the display data signal within one horizontal period of the display data signals R, G and B is inputted, stored until the next display data signal for one horizontal period is inputted from the sampling memory circuit 33 to the hold memory circuit 34, and then, outputted to the level shifter circuit 35.

The gray scale display reference voltage generating circuit 52 produces 64 reference voltages with respect to liquid crystal driving voltage output terminal for red, green and blue as described later for producing intermediate voltages for the gray scale display. The VR inputted to this circuit 52 is a voltage supplied from an external liquid crystal driving power source, while UP is digital data given by a user program such as an external control device.

The gray scale display reference voltage generating circuit 52 of the present invention is provided with a non-volatile memory 53 to which adjustment data for a gamma correction is stored.

The respective 6-bit RGB display data signals (digital) inputted from the hold memory circuit 34 and converted at the level shifter circuit 35 are converted into analog signals at the DA converter circuit 36 based upon the 64 intermediate voltages, and then, outputted to the output circuit 37.

The output circuit 37 amplifies the analog signals of 64 levels and outputs the resultant as the gray scale display voltages to the liquid crystal panel from terminals Xo-1 to Xo-128, Yo-1 to Yo-128 and Zo-1 to Zo-128 of the output terminals 38. The output terminals Xo-1 to Xo-128, Yo-1 to Yo-128 and Zo-1 to Zo-128 correspond respectively to the display data signals R, G and B. The terminals Xo, Yo and Zo each include 128 terminals.

Terminals VCC and GND of the source driver 101 are terminals for supplying power source connected to terminals VCC and GND of the controller circuit. A power source voltage and ground potential are respectively supplied thereto.

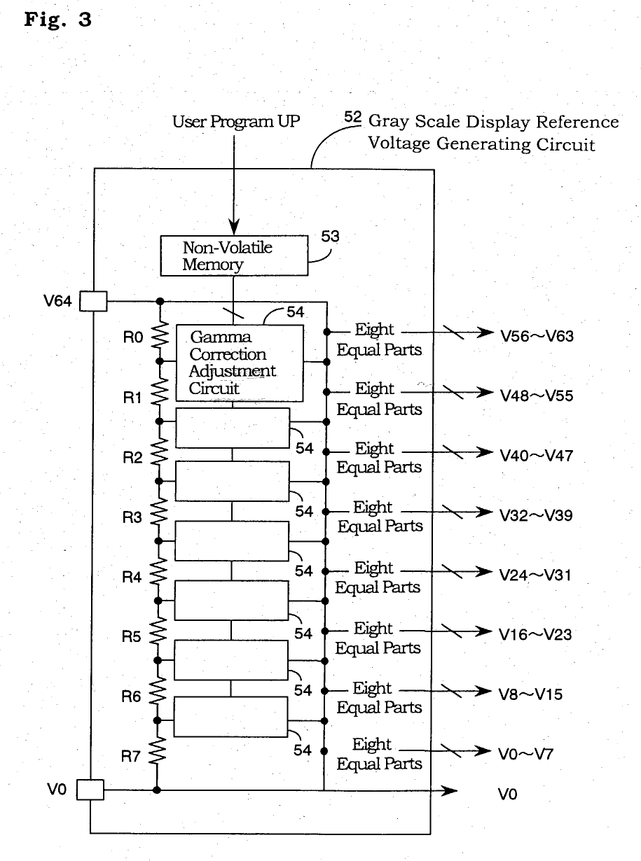

FIG. 3 is a block diagram showing a construction of the gray scale display reference voltage generating circuit 52 of the present invention.

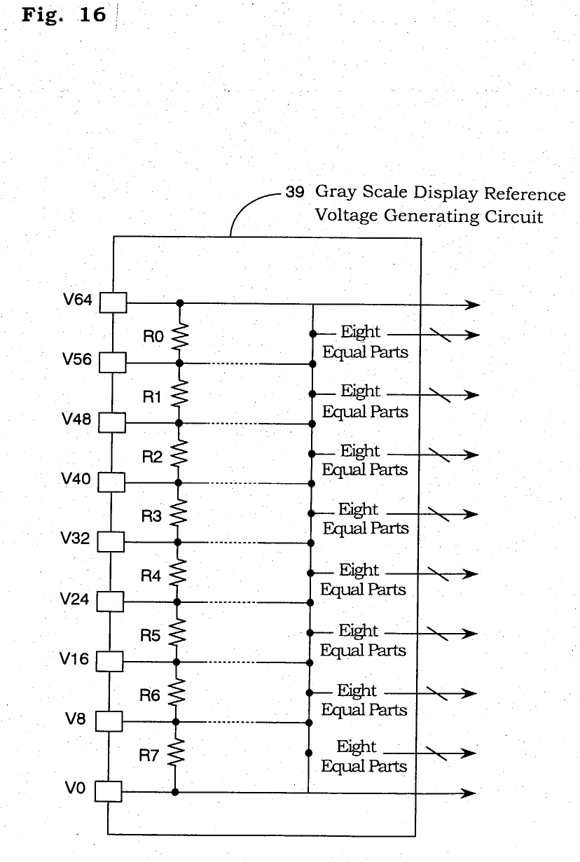

Although the gray scale display reference voltage generating circuit 52 of the present embodiment forms 64 levels of reference voltages and generates intermediate voltages similarly to the conventional gray scale display reference voltage generating circuit 39 shown in FIG. 16, the invention is not limited thereto.

The gray scale display reference voltage generating circuit 52 of the present embodiment includes two voltage input terminals of a lowest voltage input terminal V0 and a highest voltage input terminal V64, eight resistor elements R0 through R7 having resistance ratios that serve as a reference for executing a gamma correction, a gamma correction adjustment circuit 54 for upward or downward fine adjustment of each gamma-corrected reference voltage produced by the resistor elements R0 through R7 within a specified range and a non-volatile memory 53 for storing adjustment information for optionally performing the fine adjustment of a gamma correction characteristic at the gamma correction adjustment circuit 54 with a program UP or the like in accordance with the characteristics of the liquid crystal material or liquid crystal panel.

In this embodiment, the resistor elements (R0 through R7) correspond to a reference voltage generating section, the non-volatile memory 53 corresponds to the correction information storing section and the gamma correction adjustment circuit 54 corresponds to the adjustment section.

There are further a total of 64 resistors (not shown) that are in groups of eight serially connected across the lowest voltage input terminal V0 and the output, terminal of the gamma correction adjustment circuit 54, across the output terminals of the gamma correction adjustment circuits 54 and across the output terminal of the gamma correction adjustment circuit 54 and the highest voltage input terminal V64.

This construction: does not require nine gray scale voltage input terminals V0 through, V64, dissimilar to the conventional gray scale display reference voltage generating circuit 39 shown in FIG. 16, whereby the intermediate voltages can be generated and adjusted in the gray scale display reference voltage generating circuit 52.

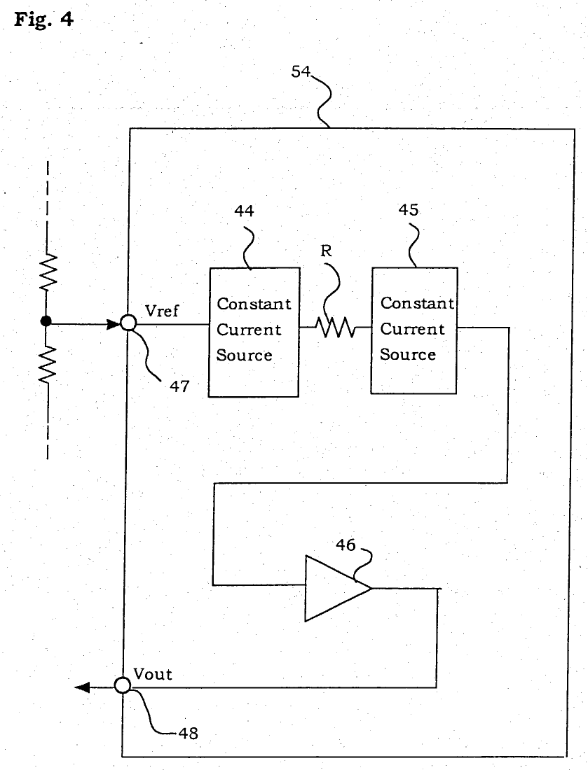

FIG. 4 is a schematic block diagram showing the construction of the gamma correction adjustment circuit 54. The gamma correction adjustment circuit 54 is constructed of one resistor element R for generating a voltage drop, two constant current sources 44 and 45 and a buffer amplifier 46. By taking advantage of the voltage drop caused by the current flowing through the resistor element R, the output voltage is adjusted by shifting the inputted voltage upward or downward by a specified voltage. The gamma correction adjustment circuit 54 having the above construction operates as follows.

That is, for example, a voltage Vref that serves as a reference is supplied to an input terminal 47 of the gamma correction adjustment circuit 54; For obtaining an output voltage higher or lower than the reference voltage Vref, a current flowing through the resistor element R is varied by the constant current sources 44 and 45, and by taking advantage of the voltage drop caused by the resistor element R, a voltage Vout obtained by shifting the inputted voltage upward or downward by the voltage drop at the resistor element R is outputted from an output terminal 48.

That is, the voltage is adjusted by the gamma correction adjustment circuit 54 so that the equation:

Vout=Vref+i·R

holds for obtaining an output voltage Vout higher than the reference voltage Vref or the equation:

Vout=Vref−i·R

holds for obtaining an output voltage Vout lower than the reference voltage Vref.

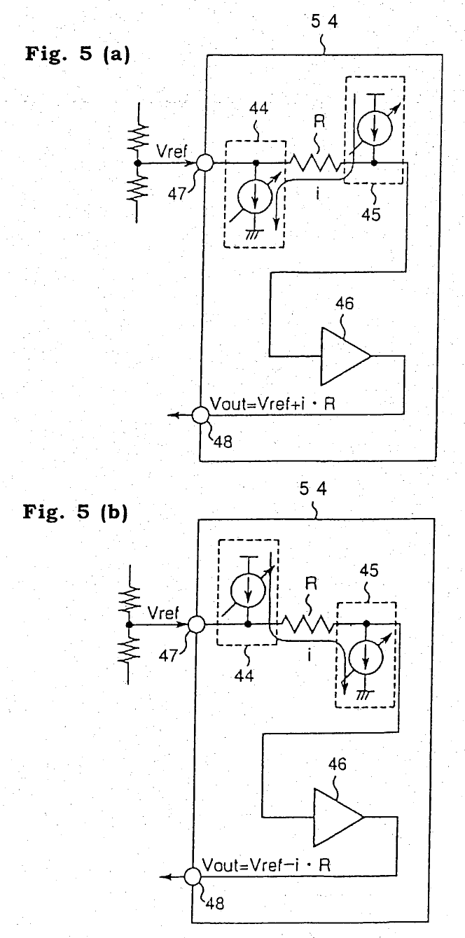

FIG. 5 shows a state in which the current flowing through the resistor element R is varied by the operations of the constant current sources 44 and 45 in the case of obtaining an output voltage Vout higher than the reference voltage Vref (FIG. 5(a)) and in the case of obtaining an output voltage Vout lower than the reference voltage Vref (FIG. 5(b)).

In the above cases, as shown in FIG. 5(a), the constant current source 44 located on the input terminal 47 side of the resistor element R is grounded and the constant current source 45 located on the output terminal 48 side is connected to the power source, whereby a current i directed in the positive direction from the constant current source 45 to the constant current source 44 flows through the resistor element R. Consequently, the output voltage Vout from the output terminal 48 when the reference voltage Vref is inputted from the input terminal 47 comes to have a voltage expressed by the equation:

Vout=Vref+i·R

which is higher than the reference voltage Vref by the voltage drop at the resistor element R.

In contrast, as shown in FIG. 5(b), the constant current source 44 is connected to the power source and the constant current source 45 is grounded, whereby a current i directed in the negative direction from the constant current source 44 to the constant current source 45 flows through the resistor element R. Consequently, the output voltage Vout from the output terminal 48 when the reference voltage Vref is inputted from the input terminal 47 comes to have a voltage expressed by the equation:

Vout=Vref−i·R

which is lower than the reference voltage Vref by the voltage drop at the resistor element R.

Then, by enabling changeover of the current value between a plurality of values with regard to the constant current sources 44 and 45 of each gamma correction adjustment circuit 54, enabling changeover between the ground and the power source and controlling the above-mentioned changeover operations based upon the adjustment data stored in the non-volatile memory 53, the gamma-corrected voltages obtained by the resistor elements R0 through R7 are finely adjusted. The thus finely adjusted voltages between the reference voltages are further divided into eight equal parts by eight resistors among the 64 resistors and they are transmitted to the D/A converter circuit 36.

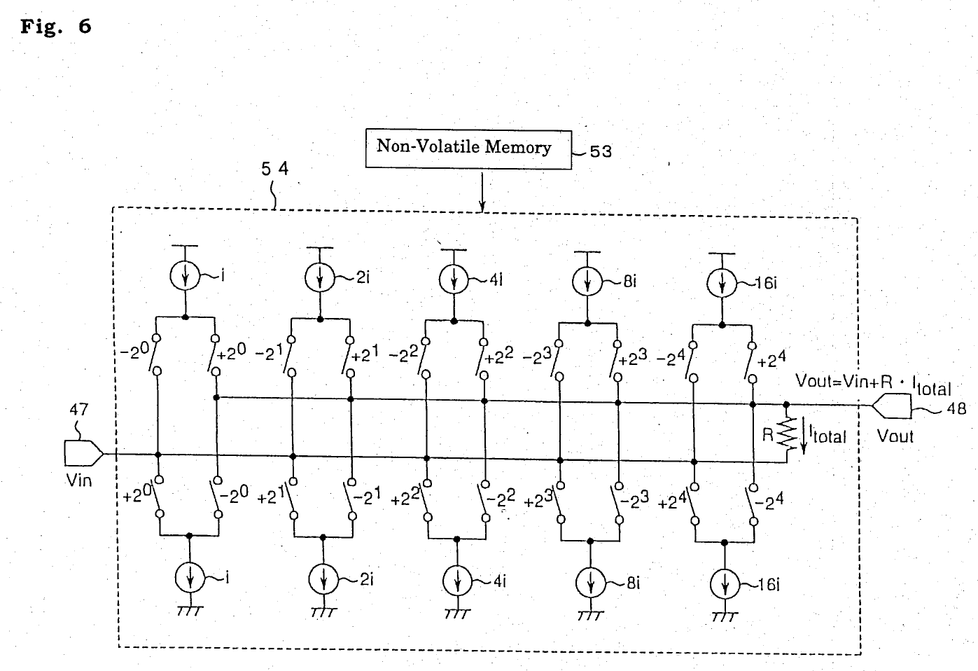

FIG. 6 shows the circuit construction of a constant current section of the gamma correction adjustment circuit 54 for executing changeover of the current values and changeover of the connection between the ground and the power source concerning the constant current sources 44 and 45. This constant current section is connected to the power source and includes five constant current sources i, 2i, 4i, 8i and 16i for generating a current 2⁽ⁿ⁻¹⁾i weighted with 2⁽ⁿ⁻¹⁾ assuming that n is a positive integer. Then, each constant current source 2⁽ⁿ⁻¹⁾i is connected to one terminal of the resistor element R and the output terminal 48 via a switch +2⁽ⁿ⁻¹⁾ turned on by a control signal +2⁽ⁿ⁻¹⁾. The constant current source 2⁽ⁿ⁻¹⁾i is further connected to the other terminal of the resistor element R and the input terminal 47 via a switch −2⁽ⁿ⁻¹⁾ turned on by a control signal −2⁽ⁿ⁻¹⁾.

Similarly, the constant current section is grounded and includes five constant current sources i, 2i, 4i, 8i and 16i for generating a current 2⁽ⁿ⁻¹⁾i weighted with the above-mentioned 2⁽ⁿ⁻¹⁾. Then, each constant current source 2⁽ⁿ⁻¹⁾i is connected to the other terminal of the resistor element R and the input terminal 47 via the switch +2⁽ⁿ⁻¹⁾ turned on by the control signal +2⁽ⁿ⁻¹⁾. The constant current source 2⁽ⁿ⁻¹⁾i is further connected to the one terminal of the resistor element R and the output terminal 48 via the switch −2⁽ⁿ⁻¹⁾ turned on by the control signal −2⁽ⁿ⁻¹⁾.

That is, the constant current source 2⁽ⁿ⁻¹⁾i connected to the input terminal 47 via the switch +2⁽ⁿ⁻¹⁾ or the switch −2⁽ⁿ⁻¹⁾ functions as the constant current source 44 of FIG. 5, and the constant current source 2⁽ⁿ⁻¹⁾i connected to the output terminal 48 via the switch +2⁽ⁿ⁻¹⁾ or the switch −2⁽ⁿ⁻¹⁾ functions as the constant current source 45 of FIG. 5. Then, by controlling the turning-on and turning-off of the switch +2⁽ⁿ⁻¹⁾ and the switch −2⁽ⁿ⁻¹⁾ on the basis of the adjustment data that is the multi-bit digital data of binary digits coded by the two's-complement stored in the non-volatile memory 53, the changeover of the current value and the changeover of connection between the power source and the ground concerning the constant current sources 44 and 45 are achieved.

With the above arrangement, the value and the direction of the current flowing through the resistor element R can be varied, allowing the outputting of the voltage Vout obtained by shifting the input voltage Vin by several steps upward or downward by the voltage drop occurring at the resistor element R. This will be described below with a specific example.

The following description is based on the assumption that the adjustment data is 6-bit data. The adjustment based on the adjustment data of the 6-bit representation enables the execution of adjustment of the gamma correction value in 64 steps ranging from −32 to +31.

Referring to FIG. 6, the constant current sources i, 2i, 4i, 8i and 16i generate currents i, 2i, 4i, 6i and 16i weighted with 2⁽ⁿ⁻¹⁾. The switch +2⁽ⁿ⁻¹⁾ and the switch −2⁽ⁿ⁻¹⁾ are turned on or off on the basis of the adjustment data of the gamma correction information stored in the non-volatile memory 53. The operation of the gamma correction adjustment circuit 54 based on the 6-bit adjustment data will be described below.

As a first case, reference is made to the case where the adjustment data is “+1:(000001)”. In this case, only two switches +2⁰ are turned on, and all the other switches are turned off. This state is the same as the state of FIG. 5(a). Specifically, a current Iₜₒₜₐₗ flowing through the resistor element R is equivalent to the constant current i, and the direction of the current is positive as described hereinabove. Therefore, the output voltage Vout is raised from the inputted reference voltage Vin by the voltage drop occurring at the resistor element R, as a consequence of which an output voltage represented by the following equation is obtained.

Vout=Vin+i×R

This is a voltage that is higher than the input reference voltage Vin by (i×R).

As another case, reference is made to the case where the adjustment data is “−9:(101001)”. In this case, a total of four switches of two switches −2³ and two switches −2⁰ are turned on, and all the other switches are turned off. This state is the same as that of FIG. 5(b). Specifically, the current Iₜₒₜₐₗ flowing through the resistor element R becomes 9i of the sum of the constant current i and the constant current 8i, and the direction of the current is negative as described hereinabove. Therefore, the output voltage Vout is lowered from the inputted reference voltage Vin by the voltage drop occurring at the resistor element R, as a consequence of which an output voltage represented by the following equation is obtained.

Vout=Vin−9i×R

This is a voltage that is lower than the input reference voltage Vin by nine times the value of (i×R).

In the case of the other adjustment data, by turning on or off the switches +2⁽ⁿ⁻¹⁾ and −2⁽ⁿ⁻¹⁾ according to the aforementioned operation, the voltage adjustment can be executed in 64 steps ranging from −32 to +31 with the voltage of (i×R) per step centered at the input reference voltage Vin.

That is, by using the multi-bit digital data of binary digits coded by the two's-complement representation as the adjustment data, the bit number n and the weight (magnification) 2⁽ⁿ⁻¹⁾ of the value of the current flowing through the resistor element R can be made to correspond to each other via the switches +2⁽ⁿ⁻¹⁾ and −2⁽ⁿ⁻¹⁾. Therefore, a quantity of adjustment of the magnification corresponding to the adjustment data of the gamma correction information stored in the non-volatile memory 53 can be obtained. That is, the quantity of adjustment of the reference value can be simply designated by the adjustment data.

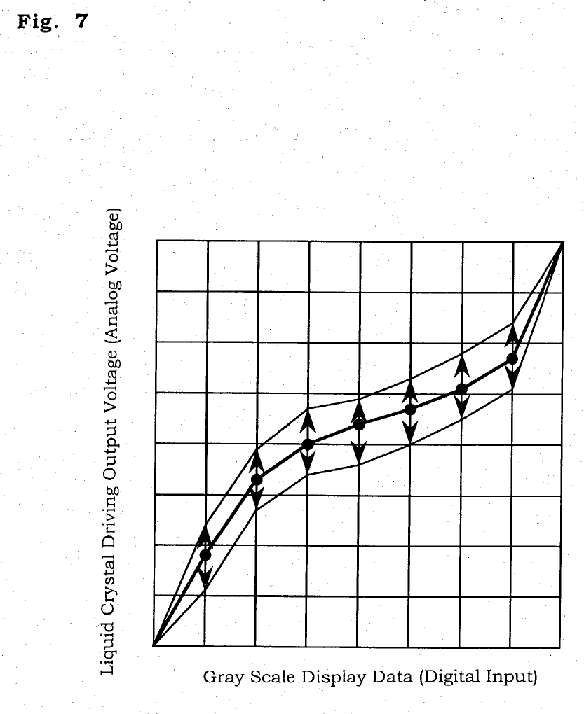

By thus turning on and off the switches +2⁽ⁿ⁻¹⁾ and −2⁽ⁿ⁻¹⁾ according to the adjustment data of the gamma correction information stored in the non-volatile memory 53, the voltage obtained by adjusting the input voltage on the basis of the adjustment data can be outputted. By applying this adjustment to the gamma correction value based on the resistor elements R0 through R7, the characteristics of the liquid crystal driving output voltage can be changed upward or downward on the basis of the adjustment data centered at the correction value based on the resistor elements R0 through R7 as, shown in FIG. 7.

Subsequently explained is the information stored in the non-volatile memory 53.

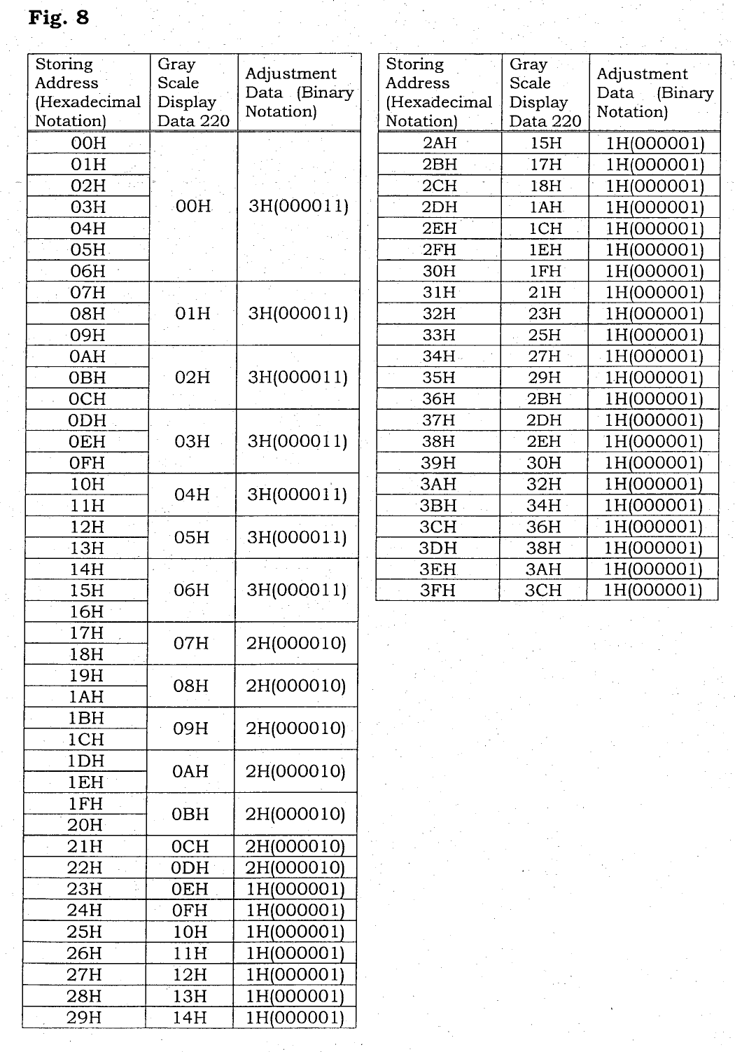

FIG. 8 shows one embodiment of the adjustment data of the invention for the gamma correction stored in the non-volatile memory 53. The information to be stored is comprised of storing address, gray scale display data 220 and adjustment data.

The storing address in FIG. 8 is an address of the non-volatile memory 53 and means output data. The gray scale display data 220 is the corrected data outputted to the gamma correction adjustment circuit 54. The adjustment data is a set value with respect to some gray scale display data. It is rewritten by a user program incorporated in the external control device.

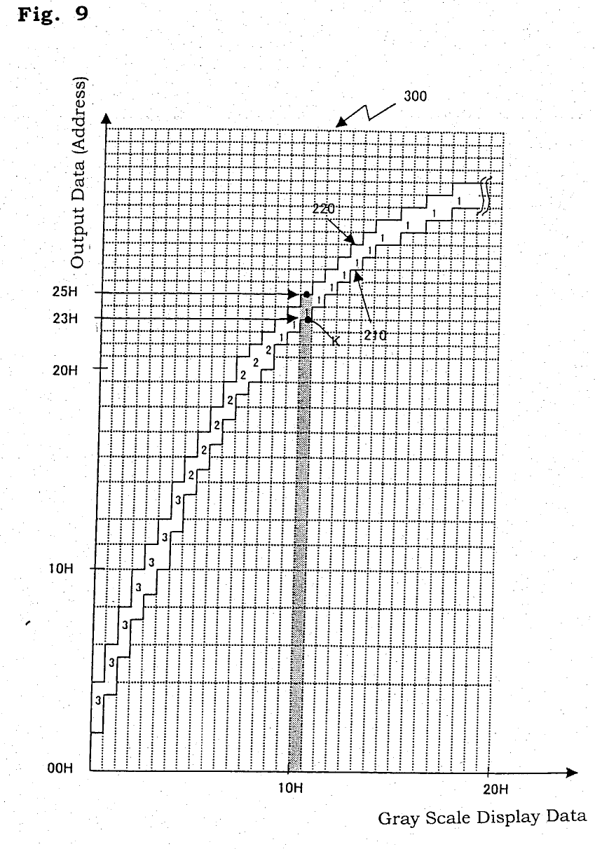

FIG. 9 shows one embodiment of a gamma correction characteristic 210 determined upon the design stage of the resistor division ratio of the gray scale display reference voltage generating circuit 52. In FIG. 9, the axis of ordinate represents the storing address of the non-volatile memory 53, while the axis of abscissa represents the gray scale display data.

The storing address shown in the axis of ordinate corresponds to the output data outputted from the non-volatile memory 53. For example, the gamma correction characteristic 210 at K point in FIG. 9 has the output data 23H (hexadecimal notation) and the gray scale display data of 10H (hexadecimal notation). Considered here is the case where the level of this output data is corrected from 23H to 25H.

Firstly, “+1(binary notation: 000001)”, for example, is stored in advance as the adjustment data in the storing address 25H of the non-volatile memory 53 that corresponds to the output data after the correction, as shown in FIG. 8. Similarly, the adjustment data that is intended to be corrected is stored in the addresses (00H to 3FH) corresponding to all combination of the bit strings in the 6-bit digital display data (see FIG. 8).

This storing process can easily be performed by operating the external control device by the user. Specifically, a simple operation by the user can easily change the quantity of the adjustment for the gamma correction. If the gamma correction characteristic can easily be changed by the user in this way, an evaluating operation for optimizing the display state can be made efficient.

FIG. 9 shows a gamma correction characteristic 220 obtained after the output data is changed based upon the adjustment data stored in the non-volatile memory 53 shown in FIG. 8. A flash memory, OTP, EEPROM, or FeRAM (ferroelectric memory) can be used for this non-volatile memory 53 in order to maintain the data once stored even if the power source is turned off.

[Second Embodiment]

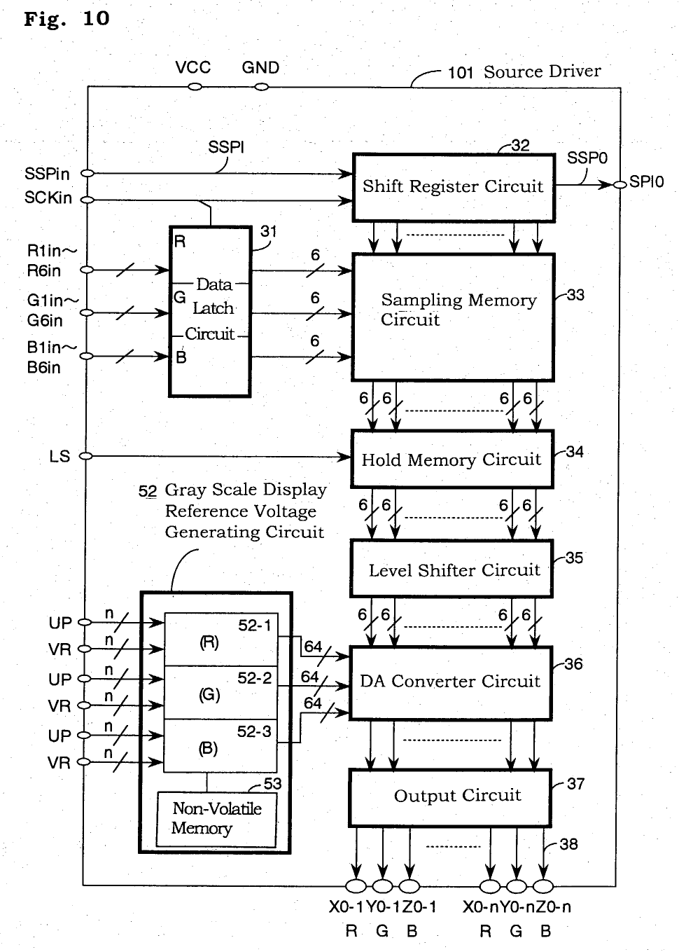

FIG. 10 is a block diagram showing a construction of a source driver according to the second embodiment using the gray scale display reference voltage generating circuit of the invention. This embodiment is characterized by including independent gamma correction circuits for every color of red (R), green (G) and blue (B) for aiming to improve a color reproduction.

Only one gray scale display reference voltage generating circuit 52 is mounted in the first embodiment shown in FIG. 1, while three gray scale display reference voltage generating circuits (52-1 for R, 52-2 for G and 52-3 for B) are provided in the second embodiment as shown in FIG. 10. The non-volatile memory 53 may be separately provided in each of the gray scale display reference voltage generating circuits like the first embodiment, or only one non-volatile memory 53 may be provided to which the adjustment data concerning all colors of R, G and B is stored.

The other constructional elements such as the shift register circuit 32 or the like shown in FIG. 10 are the same as those in the first embodiment shown in FIG. 1, and each operation of each circuit as the source driver is the same as that in the first embodiment. The difference between the first and second embodiments is that the adjustment data shown in FIG. 8 is stored for each color in the non-volatile memory 53 and 64 levels of reference voltages for every color are applied to the DA converter circuit 36 by three gray scale display reference voltage generating circuits (52-1, 52-2 and 52-3). This construction enables the gamma correction to be independently performed at every color, thereby being capable of performing an image display with a more suitable gray scale.

The non-volatile memory 53 may not only be incorporated in the source driver as described above, but also be provided in the controller 5 or the like of the display driving section which is outside the source driver. In other words, the non-volatile memory 53 can be arranged by considering the arrangement with respect to the other circuits upon designing the circuits.

In case where the non-volatile memories are provided for every source drivers, a fine adjustment can be performed even if nonuniformity in the characteristic (e.g., gray scale nonuniformity in the left and right directions in the screen) is present in the screen of the liquid crystal display device, thereby being effective, in particular, for the display device having a large screen.

[Third Embodiment]

In the above-mentioned embodiment, the adjustment data for the gamma correction is stored in the non-volatile memory 53 in the gray scale display reference voltage generating circuit 52. On the other hand, explained hereinbelow is the case where the adjustment data is stored in a “display memory” provided in the source driver 101 separate from the gray scale display reference voltage generating circuit 52, and the gamma correction adjustment circuit 54 in the gray scale display reference voltage generating circuit 52 is adjusted for every gate signal line 15. The gate signal is referred to as a scanning line or row hereinbelow.

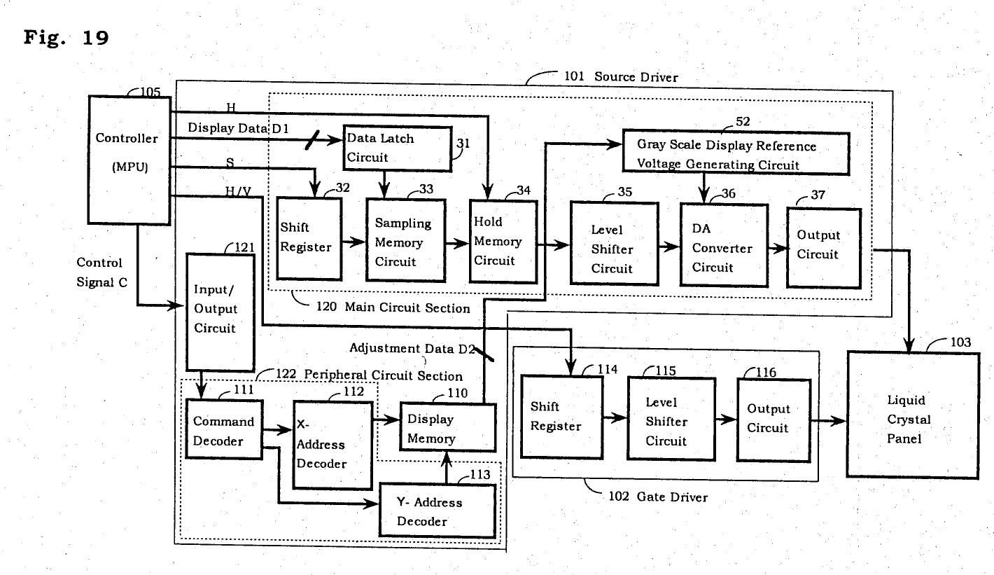

FIG. 19 is a block diagram showing a construction of a liquid crystal display device 1 according to the third embodiment of the invention.

Only main constructional elements and signal routes are shown have, and circuits and signals are not directly related to this invention are omitted such as power source circuit, clock signal, reset signal, select signal or the like.

The liquid crystal display device 1 of the invention has the liquid crystal panel 103, source driver 101, gate driver 102 and controller 105. MPU (microprocessor unit) can be used for the controller 105. This MPU corresponds to the control section.

The liquid crystal panel 103 has pixels of TFT (thin-film transistor) method composed of m pixels in the horizontal direction×n pixels in the vertical direction on m source electrodes and n gate electrodes.

It is to be noted here that a pixel array for one line in the horizontal direction is referred to as “row” and a pixel array for one line in the vertical direction is referred to as “column”. Here, m=1028×RGB, n=900. The gray scale display of 64 gray scales (6-bit) in the range of 0th gray scale and 63rd gray scale is performed in each pixel. Pixels respectively displaying R (red), G (green) and B (blue) are repeatedly aligned in each row. This consequently means that each row contains pixels of each of RGB in the number of m/3.

The source driver 101 and gate driver 102 are connected to the liquid crystal panel 103. The source driver 101 and gate driver 102 are also connected to the controller (MPU) 105.

The source driver 101 is mainly comprised of a main circuit section 120, input/output circuit 121, peripheral circuit section 122 and display memory 110.

Although the display memory 110 is not especially limited, it is constructed for storing display data of (M pixels in the horizontal direction)×(N pixels in the vertical direction). The display data stored in the display memory 110 is, for example, character data or static image data or the like that is substituted for the display data D1 or overlapped with the display data D1 to be outputted on the liquid crystal screen. Such data may be for one screen, for a plurality of screens or for a window display. In this case, a changeover switch is provided in front of or behind the hold memory 34 for executing the changeover between the data from the display memory 110 and the display data from the MPU 105.

The gamma correction adjustment data is further stored in the display memory 110. The following description is made by paying attention only to the gamma correction adjustment data D2.

Whatever the type is, the display memory 110 is desirably constructed of a non-volatile memory that holds adjustment data once stored even if the power source is turned off, the examples of which include flash memory, OTP, EEPROM, FeRAM (ferroelectric memory) or the like. In case where the display data is given as fixed data, a memory having ROM structure can be used for the display memory.

The display memory 110 may be incorporated into the source driver 101 or may be disposed outside the source driver 101.

The peripheral circuit section 122 of the source driver 101 includes a command decoder 111, X-address decoder (column decoder) 112 and Y-address decoder (row decoder) 113.

The main circuit section 120 of the source driver 101 approximately corresponds to the circuit block of the first embodiment shown in. FIG. 1, and includes the data latch circuit 31, gray scale display reference voltage generating circuit 52 (hereinafter referred to as reference voltage generating circuit), shift register 32, sampling memory 33, hold memory 34, level shifter circuit 35, D/A converter circuit 36 and output circuit 37.

The display data D1 displayed on the screen of the liquid crystal panel 103 is serially inputted to the main circuit section 120 via the MPU 105. At first, the inputted data is temporarily latched by the data latch circuit 31. The latched display data D1 is sampled by the sampling memory circuit 33 based upon the output signal of each shift register 32, and then, outputted to each corresponding hold memory circuit 34.

The hold memory 34 each corresponds to the first to mth pixels, i.e., the first to mth source electrodes included in each row in the liquid crystal panel 103. The display data inputted to the hold memory 34 is latched by the horizontal synchronization signal H, so that the display data outputted from the hold memory 34 is fixed before the input of the next horizontal synchronization signal H. The display data outputted from the hold memory 34 is subject to a level conversion such as boosting or the like at the level shifter circuit 35 for matching to the signal process level of the next D/A converter circuit 36, and then, inputted to the D/A converter circuit 36.

Inputted from the power source circuit (not shown) to the reference voltage generating circuit 52 are, for example, a maximum voltage El and minimum voltage E2 that should be applied to the pixel. The reference voltage generating circuit 52 divides the difference in the potential between the maximum voltage E1 and the minimum voltage E2, by which, in the case of the 64-gray-scale display, it generates 64 levels of the gray scale display voltages that are outputted to the D/A converter circuit 36. The D/A converter circuit 36 selects one of the gray scale display voltages corresponding to the display data from the level shifter circuit 35 per one pixel, and then, outputs the selected one to the output circuit 37.

The output circuit 37 is a low impedance conversion section comprised of a differential amplifier or the like. Each of the gray scale display voltages selected at the D/A converter circuit 36 is applied from the output circuit 37 to each of the first to mth source electrodes of the liquid crystal panel 103. The gray scale display voltage is maintained during one period for the horizontal synchronization signal H, i.e., during one horizontal synchronization period. During the next horizontal synchronization period, another gray scale display voltage corresponding to new display data is outputted.

On the other hand, the gate driver 102 includes the shift register 114, level shifter 115 and output circuit 116. When the horizontal synchronization signal H and the vertical synchronization signal V are inputted to the shift register 114 from the MPU 105, the gate driver 102 successively transfers the vertical synchronization signal V to the shift register 114 with the horizontal synchronization signal H as a clock.

Each output from the shift register 114 corresponds to the first to nth pixels included in each column of the liquid crystal panel 103, i.e., the first to nth gate electrodes. Each output from the shift register 114 is subject to the level conversion at the level shifter 115 to be boosted to a voltage capable of controlling the TFT gates possessed by each pixel. The resultant output is subject to the low impedance conversion at the output circuit 116 to be outputted therefrom to each of the first to nth gate electrodes of the liquid crystal panel 103. The output from the gate driver 102 becomes a scanning signal that controls the turning-on and turning-off of the TFT gate of each pixel in the liquid crystal panel 103.

This control turns the TFT on, the gate of which is connected to one gate electrode selected by the scanning signal. Then, the gate electrode is successively selected at every one horizontal synchronization period, whereby the pixel having the TFT that is to be turned on is successively moved in the vertical direction. At the pixel selected by the scanning signal and having the TFT that is turned on, the gray scale display voltage is applied from the source electrode to the pixel capacitor provided at this pixel, so that the pixel capacitor is charged in accordance with its potential. When the TFT is turned off, the potential is maintained at the pixel capacitor, to thereby execute the gray scale display at this pixel.

The MPU 105 gives the horizontal synchronization signal H, start pulse signal S, display data D1 and control signal C to the source driver 101. The control signal C is a signal applied from the MPU 105 to the command decoder 111 via the input/output circuit 121. It is composed of, for example, binary n-bit data. The command decoder 111 analyzes the control signal C for decoding a read-out command or write command. Further, at the command decoder 111, a desired address in the display memory 110 is selected by the X-address decoder 112 and the Y-address decoder 113, whereby the data in this address is read out or rewritten.

The input/output circuit 121 functions as an interface to the MPU 105 and an input/output buffer.

The MPU 105 instructs by using the control signal C to read out the adjustment data D2 for adjusting the gamma characteristic at only an optional line in one frame based upon the quantity of the adjustment stored in the display memory 110.

Subsequently explained is the operation of the main circuit section 120 of the source driver 101 according to the third embodiment of the invention.

A normal mode (full-screen display) will firstly be explained. In the normal mode, the display data D1 transmitted from the MPU 105 has 6-bit value corresponding to each pixel. The display data D1 is temporarily latched at the data latch circuit 31. On the other hand, the shift register 32 shifts, i.e., transfers the start pulse signal S from the MPU 105. This start pulse input signal S is output from the terminal of the MPU and shifted by the clock signal of the source driver 101 (not shown). The start pulse signal S shifted at the shift register 32 is, if eight source drivers 101 are arranged in a cascade connection, for example, successively transferred to the shift register 32 of the eighth source driver that is positioned at the eighth stage.

Each block from the shift register 32 to the output circuit 37 has m stages from the first to mth stage corresponding to the first to mth source electrodes of the liquid crystal panel 103. The display data D1 latched at the data latch circuit 31 is temporarily stored at the corresponding sampling memory 33 in synchronization with the output from the shift register 32, and then outputted to the corresponding next hold memory 34.

When the m display data D1 during one horizontal synchronization period is inputted from the sampling memory 33 to the hold memory 34, the hold memory 34 takes the display data D 1 from the sampling memory 33 by the horizontal synchronization signal H (also called a latch signal) from the MPU 105, and then outputs the same data to the next level shifter circuit 35. The hold memory 34 then holds this display data D1 until the next horizontal synchronization signal H is inputted thereto.

The MPU 105 repeatedly sends the display data D1 to the data latch circuit 31 for every one horizontal synchronization signal. This operation causes a voltage in accordance with the display data D1 to be periodically written to the liquid crystal panel 103, thereby maintaining the liquid crystal display in the liquid crystal panel 103. Further, when the MPU 105 instructs the adjustment data D2 to be read out from the display memory 110 by the control signal C, the adjustment data D2 is read out from the display memory 110 and inputted to the reference voltage generating circuit 52.

The adjustment data D2 read out from the display memory 110 by the control signal C is inputted to the reference voltage generating circuit 52, which forms 64 levels of the reference voltages for generating the intermediate voltages for the gray scale display with respect to the liquid crystal driving voltage output terminals for red, green and blue like the first embodiment.

The D/A converter circuit 36 converts each of the 6-bit RGB display data signals (digital) inputted from the hold memory 34 and converted at the level shifter circuit 35 into an analog signal based upon 64 levels of the intermediate voltages supplied from the reference voltage generating circuit 52, and then, outputs the resultant to the output circuit 37. The output circuit 37 amplifies the analog signal of 64 levels of the intermediate voltages, and then, outputs the resultant to the liquid crystal panel 103 as the gray scale display voltage.

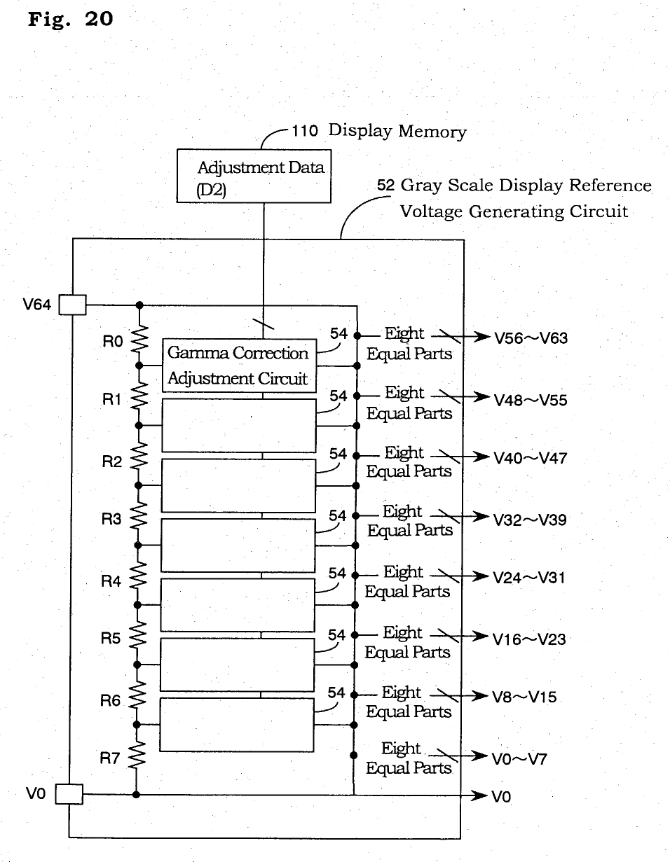

FIG. 20 is a block diagram showing a construction of the reference voltage generating circuit 52 according to the third embodiment of the invention.

Although the non-volatile memory 53 that stores the correction information is disposed in the reference voltage generating circuit 52 of FIG. 3 in the first embodiment, the display memory 110 is mounted, instead of the non-volatile memory 53, outside the main circuit section 120 in the third embodiment. The adjustment data D2 stored in this display memory 110 is read out and sent to each of the gamma correction adjustment circuit 54 in the reference voltage generating circuit 52.

The adjustment data D2 is not fixedly stored in the memory in the reference voltage generating circuit 52 but stored in the display memory 110 outside the reference voltage generating circuit 52. Accordingly the difference from the first embodiment is that the adjustment data D2 can be rewritten by the control signal C from the MPU 105 for every gate signal line.

Additionally, plural types of the adjustment data D2 are stored in advance, in the display memory 10 and the type of the adjustment data D2 to be read out is varied for every gate signal line by the control signal C, whereby the fine adjustment of the gamma correction can be performed for every gate signal line.

The circuit construction of the reference voltage generating circuit 52 shown in FIG. 20 is the same as that of the first embodiment shown in FIG. 3 in that it has two voltage input terminals V0 and V64, eight resistor elements R0 to R7, gamma correction adjustment circuit 54 for producing the gamma correction voltage, or the like.

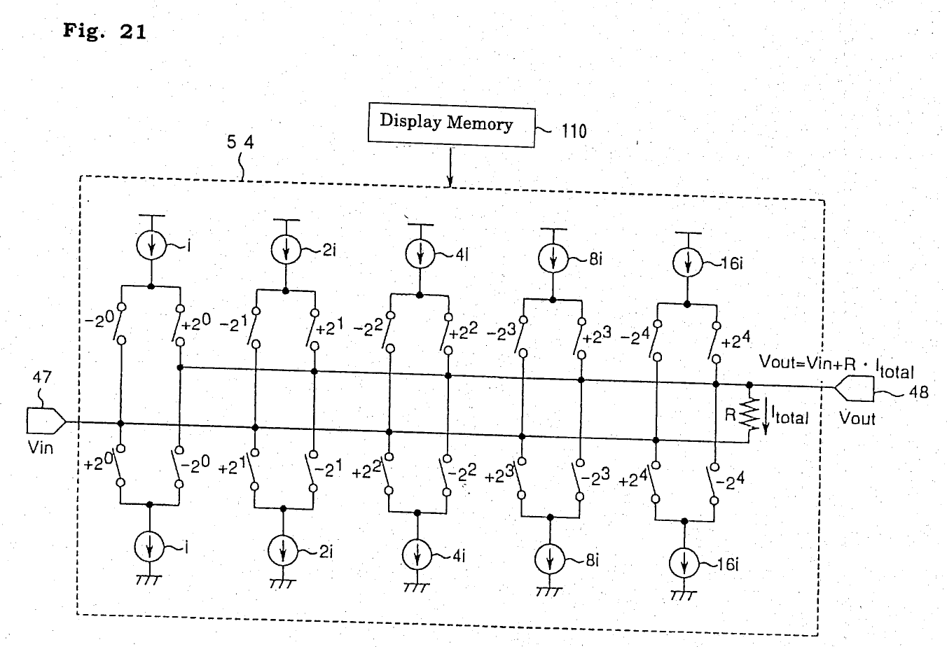

Further, the circuit construction of the gamma correction adjustment circuit 54 and the circuit construction and operation of the constant current source section are the same as those shown in FIGS. 4, 5 and 6 illustrating the first embodiment. It is to be noted that turning-on and turning-off of the switches shown in FIG. 6 are controlled based upon the adjustment data D2 applied from the display memory 110 in the third embodiment (see FIG. 21), although the turning-on and turning-off of the switches shown in FIG. 6 are controlled based upon the adjustment data stored in the non-volatile memory 53 in the first embodiment.

Turning on and off the switches +2⁽ⁿ⁻¹⁾ and −2⁽ⁿ⁻¹⁾ in accordance with the adjustment data D2 stored in the display memory 110 as described above enables the outputting of a voltage obtained by adjusting the input voltage based upon the adjustment data.

Further, two types of adjustment data are stored in the display memory 110, and a desired type of the adjustment data D2 is outputted for every gate signal line in synchronization with the scanning signal for changing over the adjustment, whereby two types of adjustments for the gamma correction are made possible.

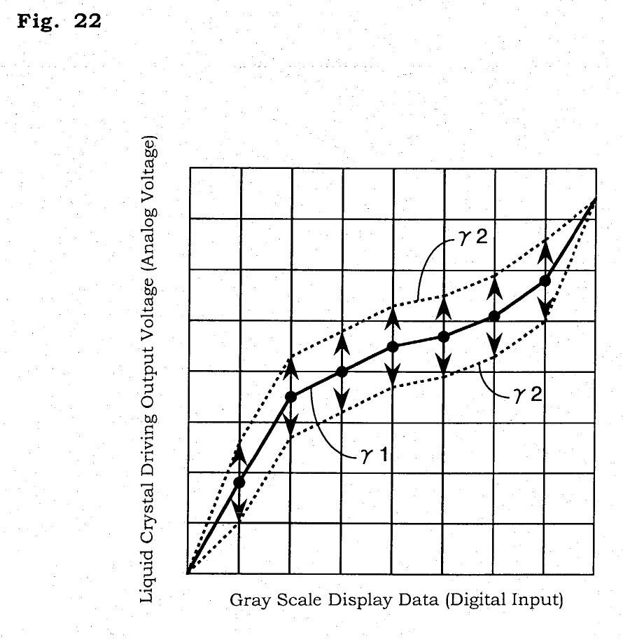

Adopting these adjustments to the gamma adjustment value based upon the resistor elements R0 to R7 can bring two gamma conversion characteristics γ2 as the characteristics of the liquid crystal driving output voltage adjusted by the adjustment data, these two gamma conversion characteristics γ2 being positioned above and below the adjustment value (gamma conversion characteristic γ1) based upon the resistor elements R0 to R7 themselves as shown in FIG. 22. Specifically, two types of gamma conversion characteristics (γ1, γ2) can be obtained.

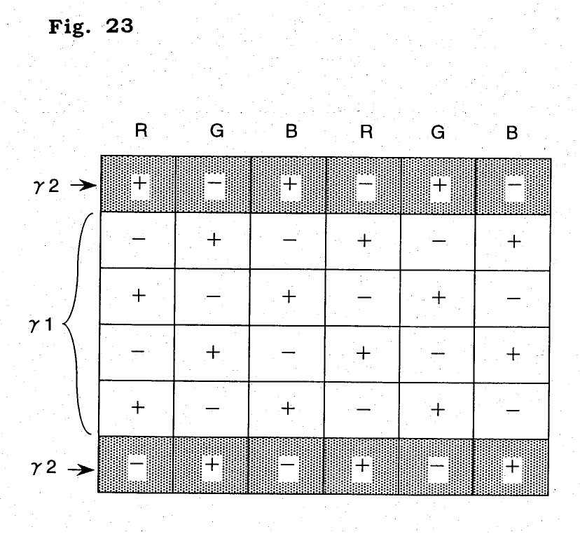

In a dot-inversion driving system shown in FIG. 23 and described later, only a predetermined line is caused to have a different gamma characteristic in one frame, so that the display characteristics can be changed to have an optimum viewing angle.

The control for the reading-out of the display memory 110 in this case may be executed such that a changeover signal in synchronization with the scanning signal is directly outputted to the display memory 110 from the MPU 105. The alternative control is as follows. Specifically, a memory area is provided in the command decoder 24, and scanning signal line number and adjustment data number (for γ1, for γ2 or the like) are, for example, stored in this memory area for performing the changeover of the scanning signal line ni to ni+j. Then, the control signal C from the MPU 105 is decoded to control the display memory 110 via the X-address decoder and Y-address decoder.

The adjustment data D2 stored in the display memory 110 is set to be rewritten by a program or the like via the MPU 105 according to need. If the data can be rewritten, the gamma correction can be adjusted corresponding to user's viewing place and angle, thus more preferable.

FIG. 23 shows an explanatory view of a pixel state in case where the liquid crystal driving is performed employing two gamma conversion characteristics γ1, γ2 shown in FIG. 22. Each cell in FIG. 23 represents one pixel dot, while a symbol “+” or “−” in each pixel dot represents a polarity of the applied signal voltage. In FIG. 23, four lines in the central portion represent pixel dots where a signal corresponding to the gamma conversion characteristic γ1 centering about the adjustment data based upon the resistor elements R0 to R7 is inputted. The upper one row and the lower one row represent pixel dots to which a signal corresponding to the gamma conversion characteristic γ2 adjusted by the adjustment data D2 is inputted.

Here, the gate signal lines and each row correspond to each other wherein only the rows corresponding to the upper and lower two gate signal lines are adjusted based upon the characteristic γ2. It is to be noted that the adjustment based upon the characteristic γ2 is not limited to two rows in FIG. 23. It can be executed to an optional row by changing the information of the control signal C.

FIG. 23 shows a liquid crystal display of the dot-inversion driving system. Specifically, it shows one example in which polarities of adjacent pixel dots are opposite to each other in one frame.

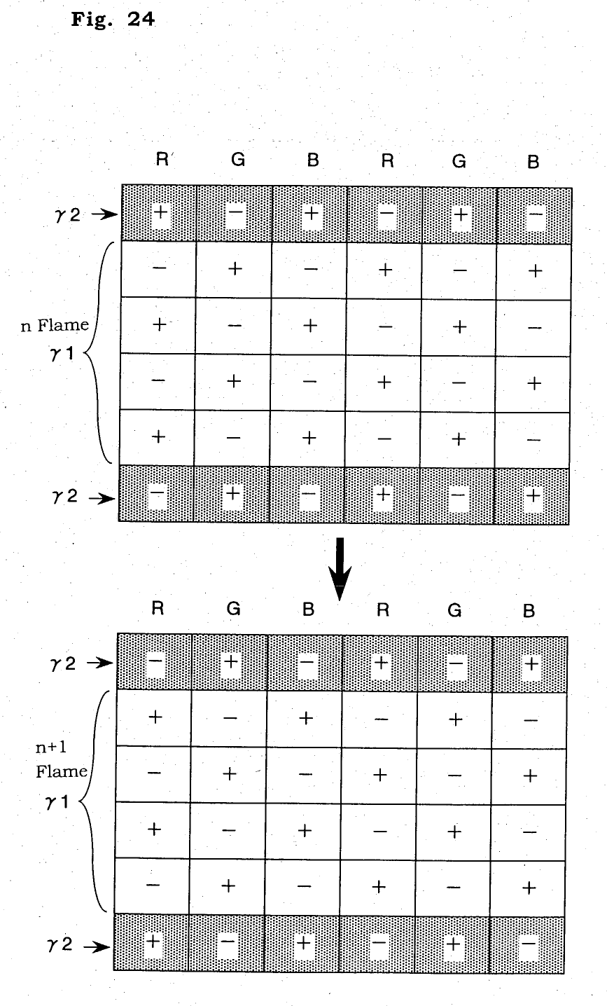

FIG. 24 is a view showing a state of the change in a pixel state in continuous frames (n frame and n+1 frame). In FIG. 24, the polarity of each pixel dot is reversed when a frame is changed from the n frame to the next n+1 frame.

As described above, the gamma conversion characteristics can be changed for every gate signal line, i.e., every row in one frame, whereby a viewing angle characteristic can be adjusted to obtain a wide viewing angle if rows to which the gamma conversion characteristic γ1 is adopted and rows to which the gamma conversion characteristic γ2 is adopted are suitably selected.

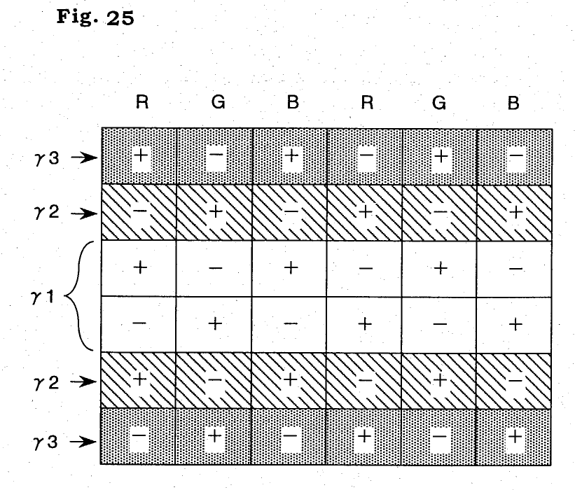

Although two types of the gamma conversion characteristics (γ1, γ2) are employed in FIGS. 23 and 24, three types or more of the gamma conversion characteristics may be used for the adjustment. The increase in the type of the gamma conversion characteristic enables a finer adjustment of a viewing angle. The liquid crystal panel is consequently uniformalized, thereby enabling the adjustment in visual color change. FIG. 25 is a view for explaining a pixel state of one embodiment in case where the gamma correction is adjusted by using three types of the gamma conversion characteristics (γ1, γ2, γ3). In this case, three types of the adjustment data D2 corresponding to each gamma conversion characteristic (γ1, γ2, γ3) are stored in the display memory 110.

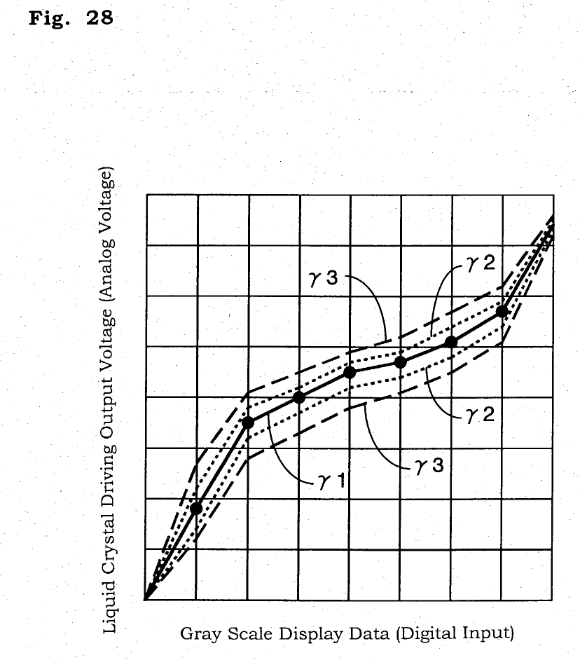

FIG. 28 shows one embodiment of the liquid crystal driving output voltages of these three gamma conversion characteristics (γ1, γ2, γ3).

For every gate signal line, the adjustment data D2 corresponding to the gate signal line is read out from the display memory 110 in synchronization with the gate scanning signal and the read-out data is applied to the reference voltage generating circuit 52. Each switch of each gamma correction adjustment circuit 54 may be changed over for every gate signal line, i.e., every row based upon this adjustment data D2.

In FIG. 25, the central row is adjusted by the characteristic γ1, the rows at both sides thereof are adjusted by the characteristic γ2 and the outermost rows are adjusted by the characteristic γ3.

Which quantity of the adjustment is applied to which row is not limited to the one shown in FIG. 25. The quantity of the adjustment may be changed depending upon the user's viewing position or viewing angle. For example, the viewing angle of a large-screen liquid crystal display is different depending upon the relative position between a viewer and the screen. Specifically, how to be viewed is different among the upper region, central region and lower region of the screen. There may be the case where the upper region is difficult to be seen, but the central and lower regions are not so difficult to be seen. Therefore, the adjustment shown in FIG. 25 cannot always be said to be suitable.

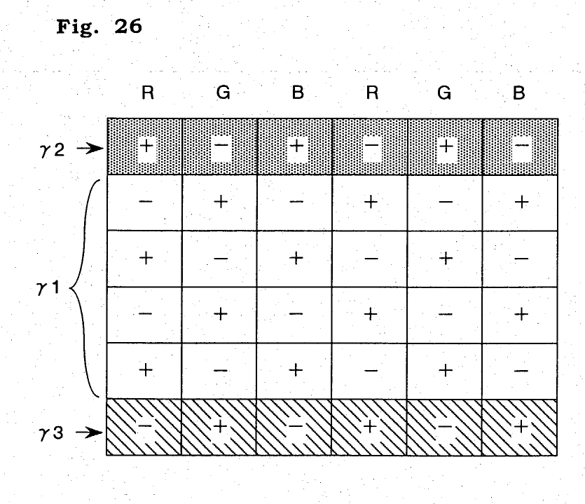

In this case, it is preferable that the gamma conversion characteristics are varied at the upper and lower sides as shown in FIG. 26. FIG. 26 is a view for explaining the case where the gamma conversion characteristics are varied at the upper and lower rows.

In FIG. 26, the gamma conversion characteristic γ2 of FIG. 28 is employed for, the upper row, while the gamma conversion characteristic γ3 of FIG. 28 is employed for the lower row. The gamma conversion characteristics γ2 and γ3 have respectively two levels of the adjustment voltages above and below the gamma conversion characteristic γ1. Which voltage is used can be determined by observing the screen.

For example, FIG. 26 is one example in which the image is totally bright. In this case, the voltage values shown below the characteristic γ1 in FIG. 28 may be utilized for both the characteristics γ2 and γ3. Adjusting the gamma characteristics at every row-unit screen area as shown in FIG. 26 enables the adjustment for widening the viewing angle in the large-screen liquid crystal display device.

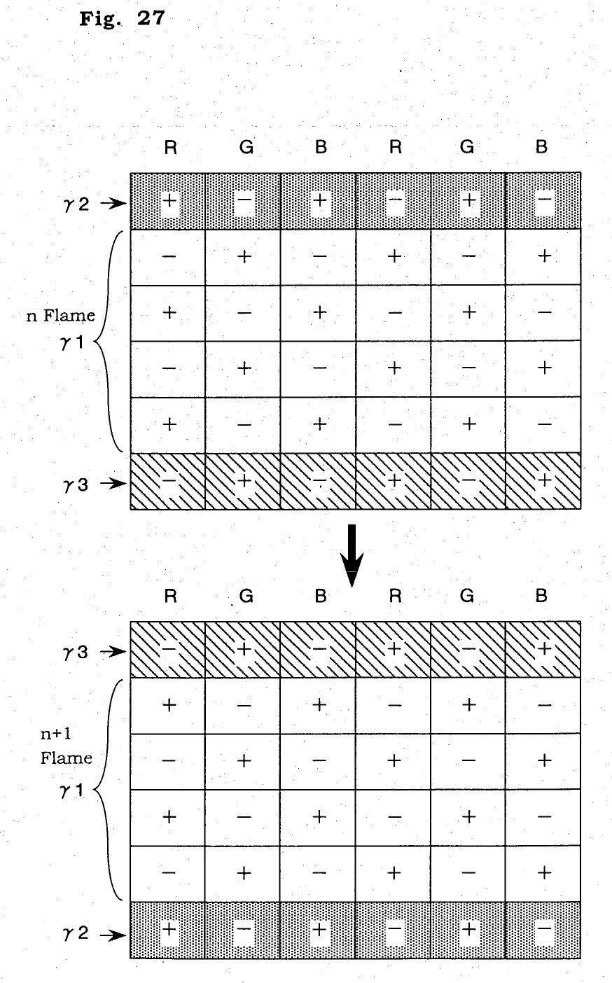

FIG. 27 is a view for explaining a change in a pixel state in continuous frames in contrast with the pixel state shown in FIG. 26. In FIG. 27, applied to each pixel dot in the n+1 frame is a voltage having reversed polarity with respect to the n frame. Further, different gamma conversion characteristics (γ2, γ3) are employed to the upper and lower rows. Adjusting the gamma correction as shown in FIG. 27 can maintain the color balance of RGB, thereby controlling a burning of the screen caused by a fixed polarization of liquid crystal or orientation film due to remaining DC voltage that is generated by an unbalance between positive and negative signals, through continuously application of voltages corresponding to the different gamma characteristics.

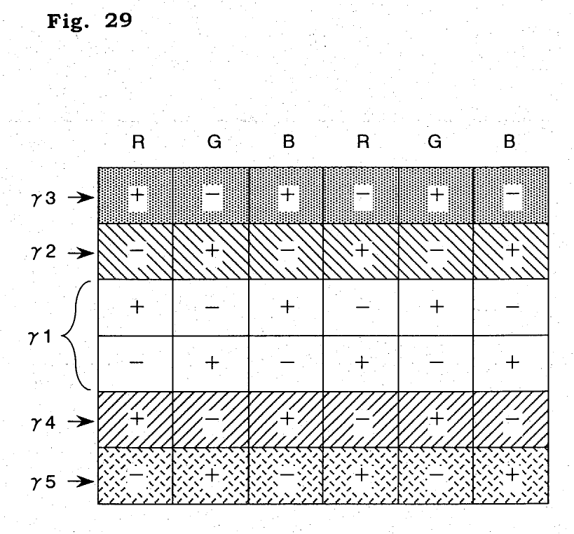

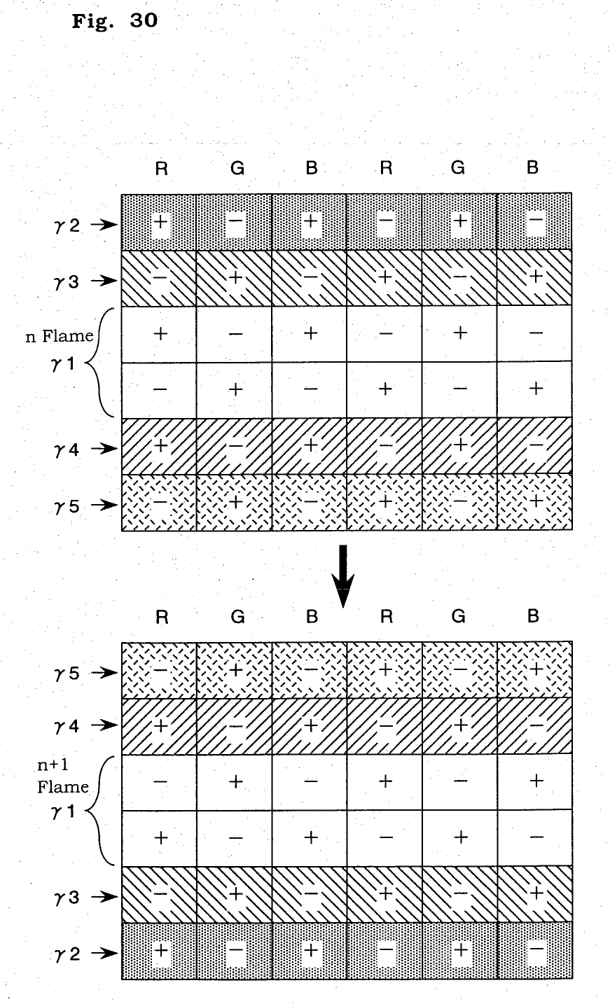

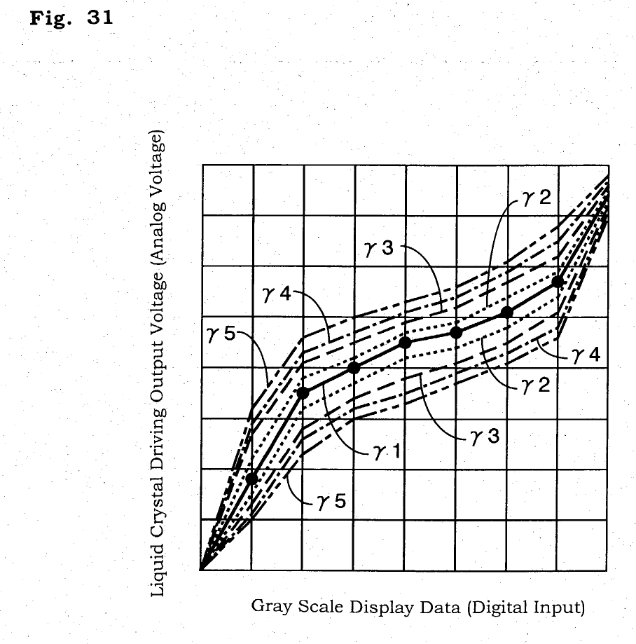

FIGS. 29 and 30 are views for explaining one embodiment of a pixel state in case where the gamma correction adjustment is performed by using five types of gamma conversion characteristics (γ1 to γ5). FIG. 31 is a view for explaining the characteristics of liquid crystal driving output voltage to five types of gamma conversion characteristics.

These figures show that the gamma conversion characteristic γ1 is employed for the central row, the gamma conversion characteristics γ2 and γ3 are employed for the upper two rows and the gamma conversion characteristics γ4 and γ5 are employed for the lower rows.

In FIG. 30, the gamma conversion characteristics of the upper two rows and lower two rows are replaced with each other in the n+1 frame.

As described above, the number of types of the gamma conversion characteristics is increased and the applied voltage is reversed to change the rows to which the gamma conversion characteristics are applied as shown in FIG. 30, resulting in that the viewing angle can finely be adjusted to obtain a wide viewing angle.

Further, as shown in FIG. 10, the gray scale display reference voltage generating circuit 52 is provided correspondingly to each of RGB, and the gamma correction is adjusted at the gamma correction adjustment circuit 54 in each gray scale display reference voltage generating circuit 52 based upon each adjustment data D2 read out from the display memory 110, whereby a more suitable gamma correction can be realized in addition to the independent adjustment of RGB.

[Fourth Embodiment]

Explained in this embodiment is the case where the gamma correction adjustment is varied for every polarity (positive (+) or negative (−)) of the signal voltage applied to each pixel.

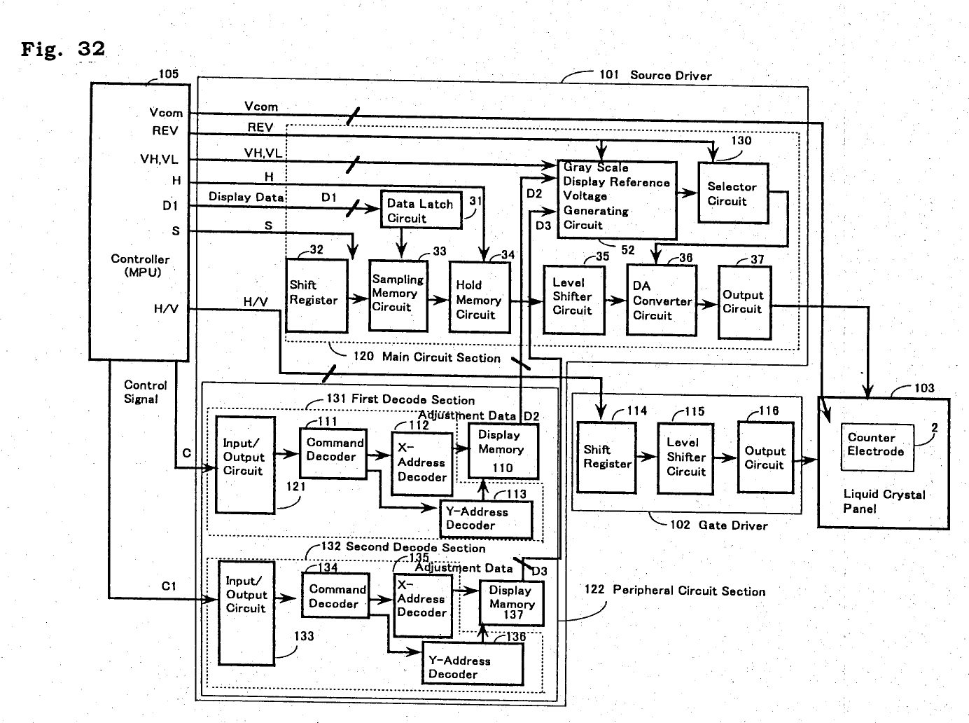

In the fourth embodiment shown below, the display memory 110 of FIG. 32 corresponds to a first storage section, a display memory 137 corresponds to a second storage section and a selector circuit 130 corresponds to a selecting section.

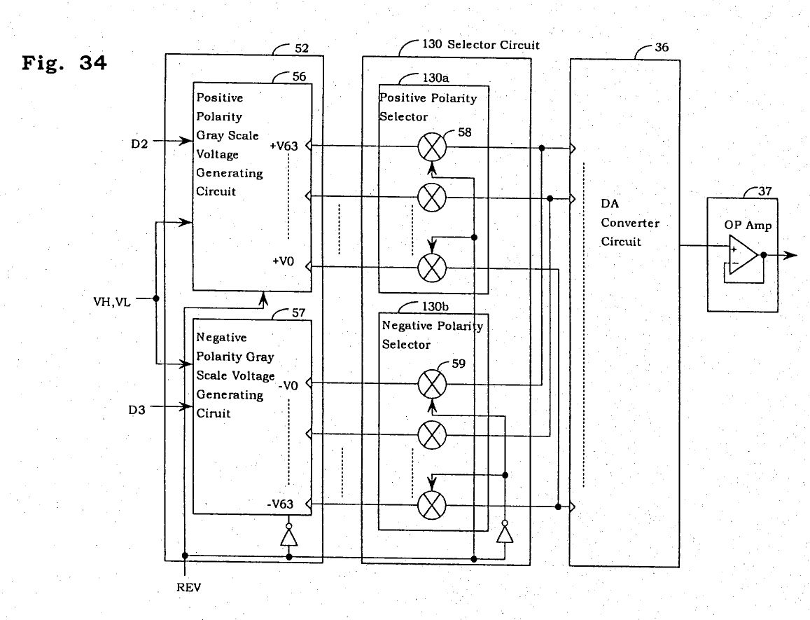

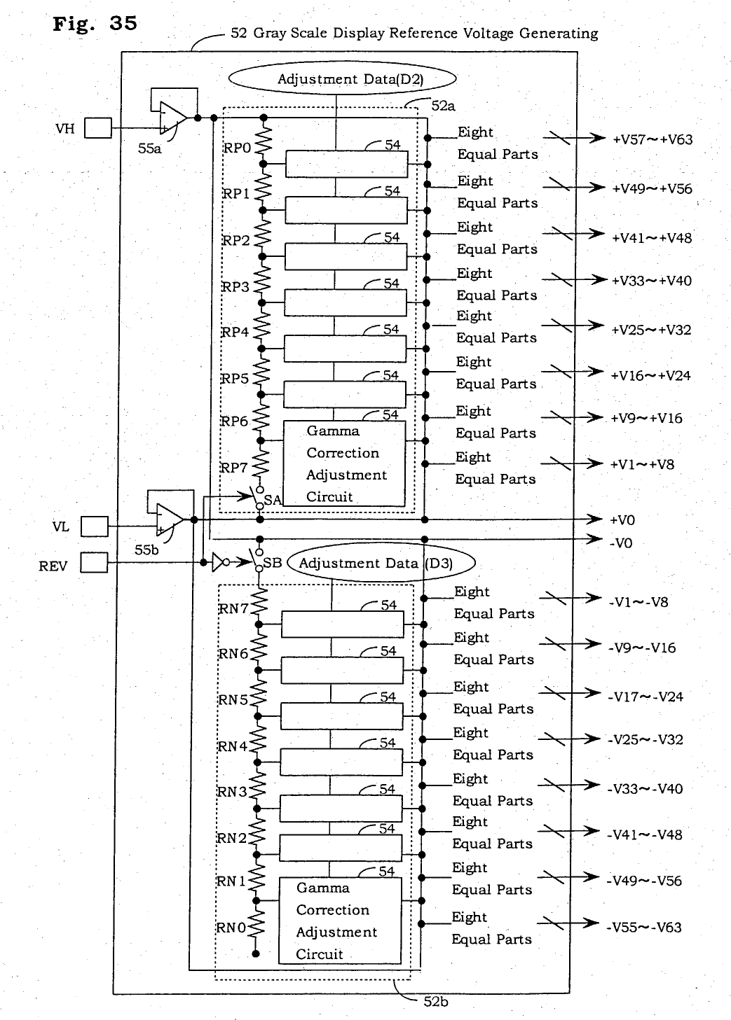

Moreover, a positive polarity gray scale voltage generating circuit 56 in FIG. 34 corresponds to a first voltage generating section, a negative polarity gray scale voltage V generating circuit 57 in FIG. 34 corresponds to a second voltage generating section, a resistor dividing circuit 52a in FIG. 35 corresponds to a first adjustment section and a resistor dividing circuit 52b in FIG. 35 corresponds to a second adjustment section.

FIG. 32 shows a block diagram of a liquid crystal display device 1 in the fourth embodiment of the invention.

The liquid crystal display device 1 in the fourth embodiment is different in construction from that of the third embodiment shown in FIG. 19 in that the following elements are newly added.

(a) selector circuit 130

(b) display memory 137 and second decoding section 132

(c) signal Vcom (counter electrode voltage)

(d) control signal C1 (from an MPU 105 to an input/output circuit 133)

(e) reference voltages VH, VL (from the MPU 105 to the reference voltage generating circuit 52)

(f) polarity inverting signal REV (from the MPU to the selector circuit 130)

(g) adjustment data D3 (from the display memory 137 to the reference voltage generating circuit 52)

The device in the fourth embodiment is, different from the third embodiment, provided with a dual address decode circuit (first decode section 131 and second decode section 132) and two display memories (110 and 137). The detail thereof will be described later.

The other constructional elements are the same as those in the third embodiment.

The liquid crystal display device 1 of the invention has the liquid crystal panel 103, source driver 101, gate driver 102 and controller 105. MPU (microprocessor unit) can be used for the controller 105. This MPU 105 corresponds to a control section.

[Construction of the Liquid Crystal Panel]

The liquid crystal panel 103 has TFT (thin-film transistor) pixels in {m pixels (m: positive integer) in the horizontal direction)×} {n pixels (n: positive integer) in the vertical direction} formed on m (m: positive integer) source electrodes and n (n: positive integer) gate electrodes.

It is to be noted here that a pixel array for one line in the horizontal direction is referred to as “row” and a pixel array for one line in the vertical direction is referred to as “column”. Here, m=1028×RGB, n=900. The gray scale display of 64 gray scales (6-bit) in the range of 0th gray scale and 63rd gray scale is performed in each pixel. Pixels respectively displaying R (red), G (green) and B (blue) are repeatedly aligned in each row. This consequently means that each row contains each pixel of RGB in the number of n.

The source driver 101 and gate driver 102 are connected to the liquid crystal panel 103. The source driver 101 and gate driver 102 are also connected to the controller (MPU) 105.

[Construction of Source Driver]

The source driver 101 is mainly comprised of a main circuit section 120 and peripheral circuit section 122. The peripheral circuit section 122 is comprised of the first decode section 131, first display memory 110, second decode section 132 and second display memory 137.

Further, the first decode section 131 is comprised of an input/output circuit 121, command decoder 111, X-address decoder 112 and Y-address decoder 113, while the second decode section 132 is comprised of an input/output circuit 133, command decoder 134, X-address decoder 135 and Y-address decoder 136.

Although the display memories 110 and 137 are not especially limited, they are constructed for storing display data of (M pixels in the horizontal direction)×(N pixels in the vertical direction).

The gamma correction adjustment data D2 and D3 are further stored in the display memories 110 and 137. The following description is made paying attention only to the gamma correction adjustment data D2 and D3.

Whatever the type is, each of the display memories 110 and 137 is desirably constructed by a non-volatile memory that maintains adjustment data once stored even if the power source is turned off, the examples of which include flash memory, OTP, EEPROM, FeRAM (ferroelectric memory) or the like. In case where the display data is given as fixed data, a memory having ROM structure can be used for the display memory. The correction data D2 and D3 stored in the display memory can be rewritten as required.

The display memories 110 and 137 may be incorporated into the source driver 101 or may be disposed outside the source driver 101.

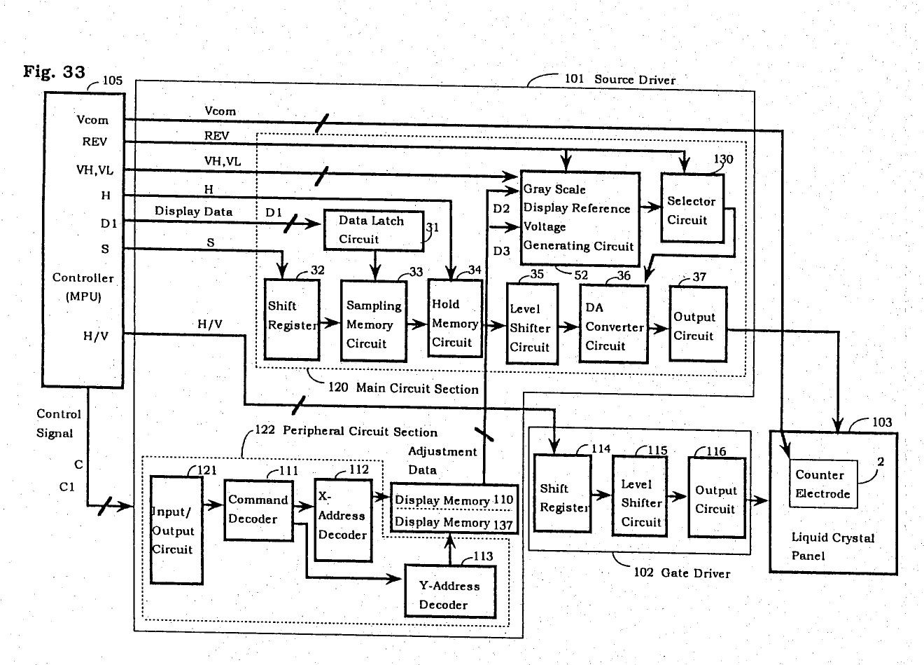

FIG. 32 shows that the display memories 110 and 137 are independently different memories, but as shown in FIG. 33, one memory may be used that is arealy divided to be used as the display memories 110 and 137.

In this case, the decode sections (131, 132) are united to one section, and the adjustment data (D2, D3) can be read out from one display memory 110 with respect to the control signals C and C1.

The construction and operation of the main circuit section 120 of the source driver 101 in the fourth embodiment are approximately the same as those in the third embodiment. The different point is that the gray scale display voltage outputted from the reference voltage generating circuit 52 is outputted to the D/A converter circuit 36 via the selector circuit 130.

The control signal C outputted from the MPU 105 is given to the input/output circuit 121 in the peripheral circuit section. The adjustment data D2 is read out from the display memory 110 by this control signal C and inputted to the resistor dividing circuit 52a of the positive polarity gray scale voltage generating circuit 56 in the reference voltage generating circuit 52 (see FIGS. 34 and 35).

On the other hand, the control signal C1 outputted from the MPU 105 is given to the input/output circuit 133. The adjustment data D3 is read out from the display memory 137 by this control signal C1 and inputted to the resistor dividing circuit 52b of the negative polarity gray scale voltage generating circuit 57 in the reference voltage generating circuit 52 (see FIGS. 34 and 35).

[Construction of Reference Voltage Generating Circuit]

FIGS. 34 and 35 show the internal circuit construction of the reference voltage generating circuit 52 in the fourth embodiment.

The reference voltage generating circuit 52 is here comprised of the positive polarity gray scale voltage generating circuit 56 and the negative polarity gray scale voltage generating circuit 57. Each generating circuit (56, 57) is comprised of buffer amplifiers (55a, 55b) and resistor dividing circuits (52a, 52b).

Further, a highest voltage input terminal VH and lowest voltage input terminal VL are provided, to which reference voltages VH and VL from the MPU 105 are respectively applied.

These reference voltages VH and VL are supplied from the MPU 105 via the external liquid crystal driving source (not shown), and respectively correspond to the voltages V₆₄ and V₀ shown in FIG. 20 illustrating the third embodiment.

The positive polarity gray scale voltage generating circuit 56 corresponds to AC driving of a positive polarity and generates analog voltages (+V₀ to +V₆₃) for the positive polarity gray scale display by the resistor dividing circuit 52a.

The negative polarity gray scale voltage generating circuit 57 corresponds to AC driving of a negative polarity and generates analog voltages (−V₀ to −V₆₃) for the negative polarity gray scale display by the resistor dividing circuit 52b.

The resistor dividing circuit 52a at the positive polarity side is constructed by resistor elements RP0 to RP7, gamma correction adjustment circuits 54 and an analog switch SA.

In the resistor dividing circuit 52a at the positive polarity side, analog voltages (+V₀ to +V₆₃) for the positive polarity gray scale display are adjusted at each gamma correction adjustment circuit 54 based upon the adjustment data D2 read out from the display memory 110 by the control signal C given from the MPU 105.

Similarly, the resistor dividing circuit 52b at the negative polarity side is constructed by resistor elements RN0 to RN7, gamma correction adjustment circuits 54 and an analog switch SB.

Similarly in the resistor dividing circuit 52b at the negative polarity side, analog voltages (−V₀ to −V₆₃) for the negative polarity gray scale display are adjusted at each gamma correction adjustment circuit 54 based upon the adjustment data D3 read out from the display memory 137 by the control signal C1 given from the MPU 105.

In FIG. 35, among the resistor elements RP0 to RP7, one connection point of RP0 is connected to the output of the buffer amplifier (voltage follower amplifier) 55a connected to the highest voltage input terminal VH, while the other terminal of the resistor RP0 is connected to RP1.

Each of the resistor elements RP1 to RP7 is constructed to have a plurality of resistor elements that are connected in serial. As to the resistor RP1, for example, fifteen resistor elements RP1-1, RP1-2, . . . RP1-15 are serially connected to form the resistor RP1. As to the other resistor elements RP2 to RP7, sixteen resistor elements are serially connected to form each of the resistor elements RP2 to RP7.

One terminal of the RP7 is connected to the RP6, while the other terminal of the RP7 opposite to the RP6 is connected to the output of the buffer amplifier (voltage follower amplifier) 55b connected to the lowest voltage input terminal VL via the analog switch SA.

Among the resistor elements RN0 to RN7, one connection point of RN0 is connected to the output of the buffer amplifier 55b connected to the lowest voltage input terminal VL, while the other terminal of the resistor RN0 is connected to RN1.

Each of the resistor elements RN1 to RN7 is constructed to have a plurality of resistor elements that are connected in serial. As to the resistor RN1, for example, fifteen resistor elements RN1-1, RN1-2, . . . RN1-15 are serially connected to form the resistor RN1. As to the other resistor elements RN2 to RN7, sixteen resistor elements are serially connected to form each of the resistor elements RN2 to RN7.

One terminal of the RN7 is connected to the RN6, while the other terminal of RN7 opposite to the RN6 is connected to the output of the buffer amplifier (voltage follower amplifier) 55a connected to the highest voltage input terminal VH via the analog switch SB.

Thus, in the fourth embodiment, there is no need to provide nine intermediate voltage input terminals V0 to V64 like the conventional gray scale display reference voltage generating circuit. Specifically, the intermediate voltage can be generated and adjusted in the reference voltage generating circuit 52.

The resistance values of the resistor dividing circuits (52a, 52b) can be made higher by the buffer amplifiers 55a and 55b (voltage follower amplifiers) connected respectively to the highest voltage input terminal VH and lowest voltage input terminal VL, thereby controlling the current values flowing through the resistor dividing circuits.

The polarity inverting signal REV outputted from the MPU 105 is given to the analog switches (SA, SB) in the resistor dividing circuits (52a, 52b) at the reference voltage generating circuit 52 as shown in FIG. 35. Either one of the resistor dividing circuits (52a, 52b) is selected by this signal REV.

For example, when the signal REV is “H”, the analog switch SA is turned on (open state) and the analog switch SB is turned off (close state), so that the resistor dividing circuit 52a is selected for outputting the analog voltages (+V₀ to +V₆₃) for the positive polarity gray scale display.

On the contrary, when the signal REV is “L”, the analog switch SA is turned off (close state) and the switch SB is turned on (open state), so that the resistor dividing circuit 52b is selected.

This signal REV makes the switches conductive (open state) when the additional voltage given to the gates of the analog switches (SA, SB) is “H”.

[Construction of Selector Circuit]

The selector circuit 130 has a positive polarity selector circuit 130a and a negative polarity selector circuit 130b as shown in FIG. 34 corresponding to the positive polarity gray scale voltage generating circuit 56 and the negative polarity gray scale voltage generating circuit 57. Each selector circuit (130a, 130b) is constructed to have a plurality of analog switches (58, 59) provided so as to correspond to each analog voltage (V₀ to V₆₃) outputted from the voltage generating circuits (56, 57).

Each analog switch 58 of the selector circuit 130a is connected to each output terminal of the analog voltages (+V₀ to +V₆₃) from the positive polarity resistor dividing circuit 52a, while each analog switch 59 of the selector circuit 130b is connected to each output terminal of the analog voltages (−V₀ to −V₆₃) from the negative polarity resistor dividing circuit 52b.

Each analog switch (58, 59) is selected to be turned on or turned off by the polarity inverting signal REV, whereby the presence or absence of the output of each analog voltage (V₀ to V₆₃) to the DA converter circuit 36 is controlled.

When the signal REV is “H”, for example, the analog switch 58 of the selector circuit 130a is selected, so that the analog voltages having positive polarities (+V₀ to +V₆₃) are outputted. When the signal REV is “L”, the analog switch 59 of the selector circuit 130b is selected, so that the analog voltages having negative polarities (−V₀ to −V₆₃) are outputted.

The construction of the gamma correction adjustment circuit 54 or the like is the same as that shown in FIGS. 4, 5 and 6 illustrating the first embodiment. In the fourth embodiment, ON/OFF control of each switch is controlled based upon the adjustment data (D2) given from the display memory 110 and the adjustment data (D3) given from the display memory 137 as shown in FIG. 21 of the third embodiment.

The fourth embodiment enables the obtainment at the gamma correction adjustment circuit 54 of the quantity of adjustment having a magnification ratio in accordance with two adjustment data D2, D3 stored respectively in the display memories 110, 137 instead of the adjustment data of the gamma correction information stored in the non-volatile memory 53 of the first embodiment. In other words, turning on or turning off the switches +2⁽ⁿ⁻¹⁾, −2⁽ⁿ⁻¹⁾ in accordance with the adjustment data D2, D3 enables the output of the voltage obtained by adjusting the input voltage based upon the adjustment data.

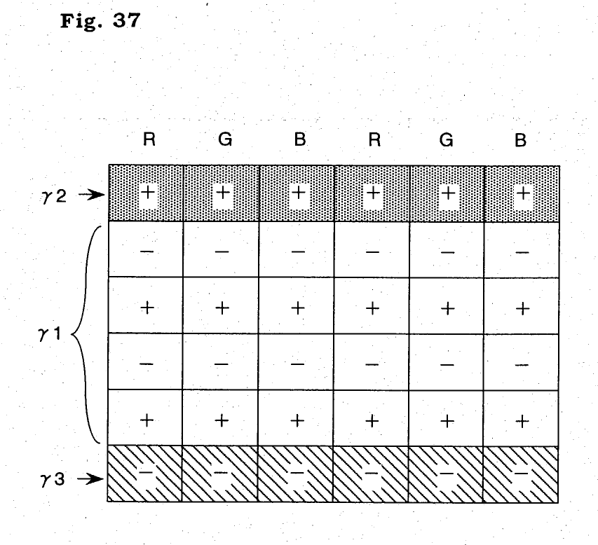

When this adjustment is adopted to the gamma correction value based upon the resistor elements R0 to R7, the gamma conversion characteristic γ1 centered about the adjustment value based upon the resistor elements R0 to R7 and the gamma conversion characteristics γ2 and γ3 that can be adjusted by the adjustment data D2 and D3 can be obtained in the liquid crystal driving output voltage characteristics. These three gamma characteristics γ1 as well as γ2 and γ3 can be changed to have an optimum viewing angle by adopting them to optional lines in one screen shown in FIG. 37 described later.

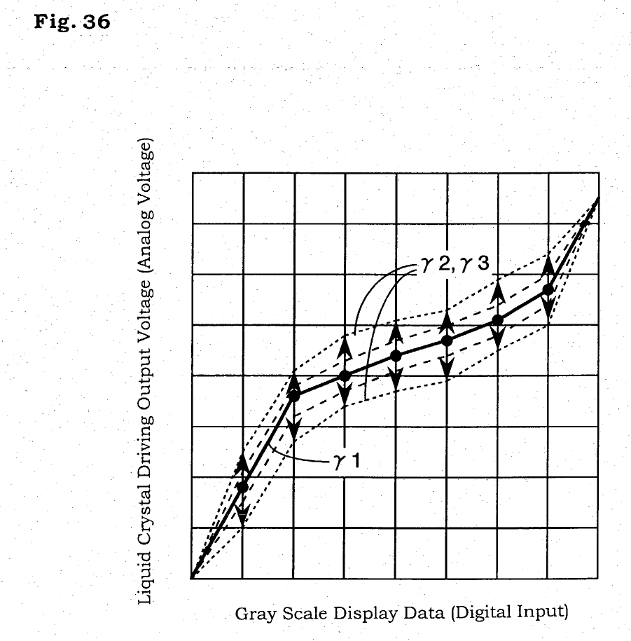

FIG. 37 is a view for explaining a pixel state in case where the gamma conversion characteristic γ1 explained with reference to FIG. 36 as well as the gamma conversion characteristics γ2 and γ3 adjusted by the adjustment data D2, D3 are adopted to the liquid crystal display device.

Although FIG. 23 of the third embodiment represents the pixel state by the dot-inversion driving system, FIG. 37 represents the case where the liquid crystal display device is driven by a line-driving system. Specifically, positive polarities and negative polarities are alternately changed in one scanning line in FIG. 23, while all pixels in one scanning line have positive polarities (+) or negative polarities (−) in FIG. 37.

In FIG. 37, the sections that are not hatched represent pixel dots having inputted thereto a signal corresponding to the gamma conversion characteristic γ1 centered about the correction value based upon the resistor elements R0 to R7, while the hatched sections represent pixel dots having inputted thereto a signal corresponding to the gamma conversion characteristics γ2 and γ3 adjusted by the adjustment data D2 and D3. The signs of ± in the pixel dots represent polarities of the applied signals.

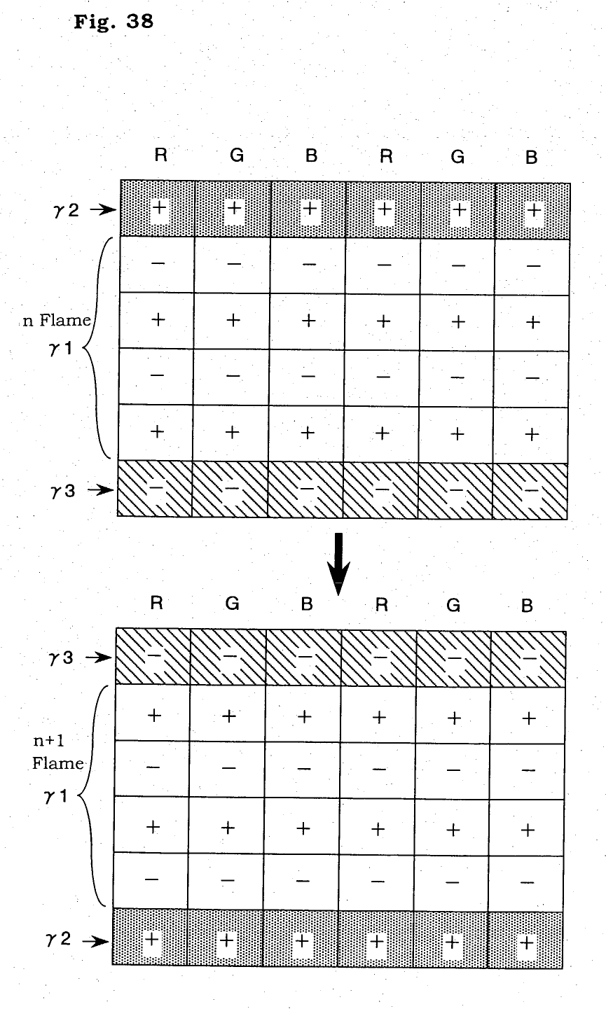

Further, FIG. 38 shows changes in the pixel state in the two continuous frames of the liquid crystal display device shown in FIG. 37. The polarities are inverted in the n+1 frame with respect to the n frame.

As described above, adopting three different gamma conversion characteristics to an optional line in one screen can bring a wide viewing angle. It is needless to say that viewing angle characteristics can be changed in a wide range by adopting three or more gamma conversion characteristics.

As described above, the gamma correction value is adjusted (γ2 in FIG. 37) in the scanning line having positive polarity by using the adjustment data D2 stored in the display memory 110, while the gamma correction value is adjusted (γ3 in FIG. 37) in the scanning line having negative polarity by using the adjustment data D3 stored in the display memory 137, so that optimum adjustment in visual color change can be realized.

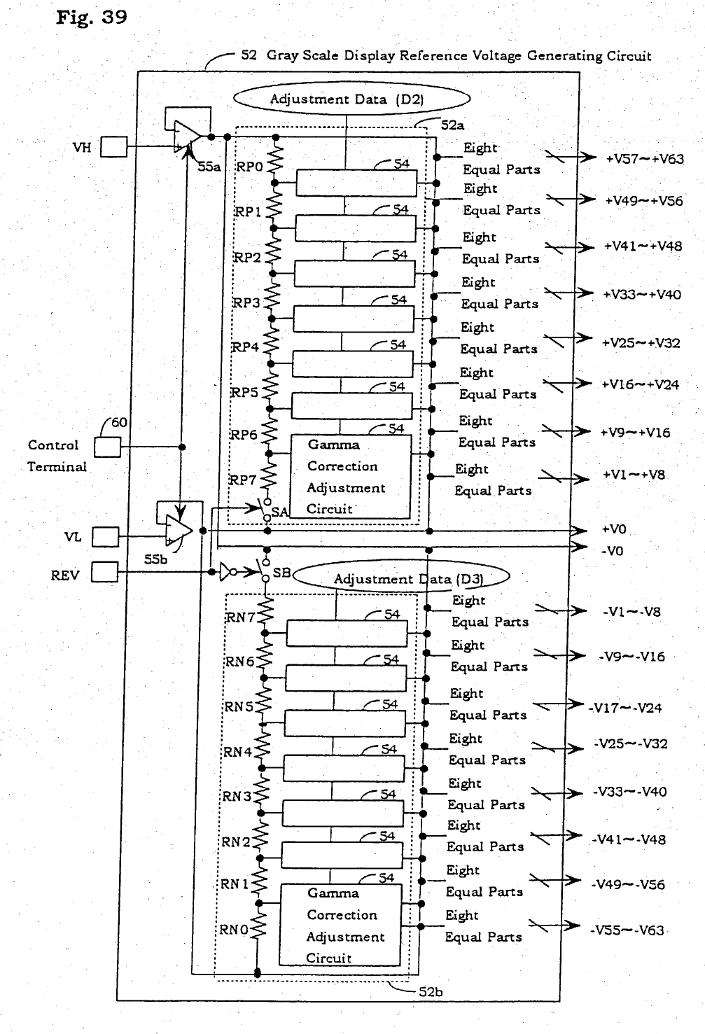

FIG. 39 shows an example of the other construction of the reference voltage generating circuit 52 in the fourth embodiment.

A control terminal 60 is provided for controlling the operations of the buffer amplifiers (55a, 55b) in contrast to the one shown in FIG. 35.

The control terminal 60 is connected to the MPU 105 from which a signal of “H” level or “L” level is given thereto.

For example, when the “H” level signal is applied to the control terminal 60, the buffer amplifiers (55a, 55b) become conductive, so that 64 levels of reference voltages having positive polarities (+V0 to +V63) or 64 levels of reference voltages having negative polarities (−V0 to −V63) are generated based upon the input reference voltages VH or VL.

When the “L” level signal is applied to the control terminal 60, the buffer amplifiers (55a, 55b) become non-conductive to stop the operations, so that the reference voltage is not generated.

Stopping the operations of the buffer amplifiers (55a, 55b) suspends the generation of the voltage by the reference voltage generating circuit 52, thereby obtaining a reduced power consumption.

The buffer amplifier provided in the gamma correction adjustment circuit 54 that is not shown may be controlled by the same signal.

For example, the operating current of the analog circuit typically represented by the buffer amplifiers (55a, 55b) having large power consumption is de-energized during a non-display period of the liquid crystal display device or processing period of the horizontal synchronization that is a non-display period of the screen, whereby reduced power consumption can be obtained in the liquid crystal display device.

According to the present invention, the adjustment data for the gray scale correction is stored in the non-volatile memory, thereby preventing the circuit structure from being complicated, even if the length of the digital display data is long. Consequently, the operation for changing the adjustment data is facilitated.

Further, the adjustment data can be changed only by rewriting the adjustment data stored in the non-volatile memory, and thereby the reference voltage can be easily adjusted in accordance with the characteristics of the liquid crystal material or liquid crystal display device without remaking the driving circuit for the liquid crystal display or the like. Accordingly, it can be adopted to a liquid crystal display device having different property, so that the circuit for the gray scale display can be rationalized and commonized. Consequently, a manufacturing cost can be reduced. Moreover, a gray scale adjustment can independently be performed for every color component, and thereby the display quality of the liquid crystal display device can be more finely controlled.

According to the liquid crystal display device of the present invention, output voltages of different gamma characteristics can be applied to desired gate signal lines in one frame, whereby the characteristic can be changed to have an optimum viewing angle. Further, the adjustment in a visual color change is made possible, resulting in that a manufacturing process of the liquid crystal panel is not complicated, manufacturing conditions are not so strict and the adjustment data can easily be adjusted even after the liquid crystal display device is completed.

According to the present invention, adjustment data in the case of applying a voltage having positive polarity and adjustment data in the case of applying a voltage having negative polarity are separately stored for adjusting the reference voltage for the gray scale display every scanning lines to which the positive voltage is applied and every scanning lines to which the negative voltage is applied. Therefore, the adjustment in visual color change corresponding to polarities can suitably be performed.

Moreover, the gamma correction can be more finely adjusted particularly in a liquid crystal display device wherein display characteristic upon applying a positive voltage is different from that upon applying a negative voltage.

Additionally, quantity of adjustment, i.e., gray scale display data is stored in the non-volatile memory and its content is rewritten according to need, and thereby the reference voltage can be easily adjusted in accordance with the characteristics of the liquid crystal material or liquid crystal display device without remaking the driving circuit for the gray scale display in the reference voltage generating section or the like.

Consequently, the circuit for the gray scale display can be rationalized and commonized, and thereby the manufacturing cost of the liquid crystal display device can be reduced.

What is claimed is:

1. A gray scale display reference voltage generating circuit for generating a reference voltage for a gray scale display used for performing digital/analog conversion on display data comprising:
a reference voltage generating section for producing reference voltages of a plurality of levels;
a correction information storing section for storing quantity of adjustment for the reference voltages; and
an adjustment section for adjusting the reference voltages based upon the quantity of adjustment stored in the correction information storing section.

2. A gray scale display reference voltage generating circuit according to. Claim 1, wherein the correction information storing section is constructed by a non-volatile memory.

3. A gray scale display reference voltage generating circuit according to either one of claims 1 and 2, wherein the reference voltage generating section, the correction information storing section and the adjustment section are independently provided for every one of a plurality of color components.

4. A liquid crystal display device provided with a gray scale display reference voltage generating circuit as claimed in any one of claims 1 to 3.

5. A liquid crystal display device comprising:
a reference voltage generating section for producing a plurality of reference voltages for a gray scale display used for performing digital/analog conversion on display data;
a correction information storing section for storing quantity of adjustment of one type or quantities of adjustment of a plurality of types with respect to the reference voltages;
an adjustment section for adjusting the produced reference voltages based upon the quantities of adjustment stored in the correction information storing section; and
a control section for controlling an operation of the adjustment section,
wherein the control section reads out the quantities of adjustment of different types from the correction information storing section for every predetermined number of scanning lines in one frame of a display screen, and gives the read-out quantities of adjustment to the adjustment section.

6. A liquid crystal display device according to claim 5, wherein the adjustment section adjusts the reference voltages based upon the given quantities of adjustment in synchronization with a scanning signal for displaying the display screen.

7. A liquid crystal display device according to either one of claim 5 and 6, wherein the correction information storing section is comprised of a rewritable non-volatile memory and the control section rewrites the stored quantities of adjustment.

8. A liquid crystal display device according to claim 5, wherein the correction information storing section comprises a first storage section for storing first adjustment data in case where a voltage having positive polarity is applied to a pixel and a second storage section for storing second adjustment data in case where a voltage having negative polarity is applied to a pixel,
the reference voltage generating section comprises a first voltage generating section for producing a reference voltage for a positive polarity gray scale display and a second voltage generating section for producing a reference voltage for a negative polarity gray scale display,
the adjustment section comprises a first adjustment section for adjusting the reference voltage produced by the first voltage generating section based upon the first adjustment data stored in the first storage section and a second adjustment section for adjusting the reference voltage produced by the second voltage generating section based upon the second adjustment data stored in the second storage section, and
the liquid crystal display device further comprising a selecting section for selecting either one of the adjusted reference voltages outputted from the first and second adjustment sections based upon a polarity inverting signal applied from the control section,
wherein a gray scale correction is performed for every scanning line based upon the selected reference voltage.

9. A liquid crystal display device according to claim 8, wherein the first and second storage sections are formed of a single non-volatile rewritable memory.
